(19) United States
(12) Patent Application Publication
(10) Pub. No.: US 2020/0371491 A1
(43) Pub. Date: Nov. 26, 2020

(54) Determining Operating State from Complex Sensor Data

(71) Applicant: GB GAS HOLDINGS LIMITED, Windsor, Berkshire (GB)

(72) Inventor: Timothy WONG, Windsor, Berkshire (GB)

(21) Appl. No.: 16/759,001

(22) PCT Filed: Oct. 25, 2018
(86) PCT No.: PCT/GB2018/053090

§ 371 Date: Apr. 24, 2020

(30) Foreign Application Priority Data
Oct. 26, 2017 (GB) 1717651.2

(51) Int. Cl. G05B 19/406; G06N 3/08

(52) U.S. Cl. CPC G05B 19/406; G05B 2219/31449; G06N 3/08

(57) ABSTRACT

A method of detecting an operating state of a process, system or machine based on sensor signals from a plurality of sensors is disclosed. The method comprises receiving sensor data, the sensor data based on sensor signals from the plurality of sensors and providing the sensor data as input to a neural network. The neural network comprises an encoder sub-network arranged to receive the sensor data as input and to generate a context vector based on the sensor data; and a decoder sub-network arranged to receive the context vector as input and to regenerate sensor data corresponding to at least a subset of the sensors based on the context vector. The method comprises comparing the context vector to at least one context vector classification; detecting an operating state in dependence on the comparison; and outputting a notification indicating the detected operating state.

The present invention relates to systems and methods for analysing sensor data to detect operating conditions and faults in a system, for example in industrial processes or machines.

Modern industrial processes are often monitored by a large array of sensors. Vital data is usually displayed on the equipment panel or streamed to computerised real-time dashboards in the control room. Automated rule-based systems are commonly in place to monitor streams of real-time sensor readings. For instance, warning alarms can be triggered if a vital sensor reaches a pre-set threshold value. This allows operators to intervene in time and apply corrective actions appropriately. However, the process state may continue to worsen if manual intervention fails to resolve the problem. This could eventually trigger automated shutdown when the process reaches the critical state. The intention is to guarantee safety and protect the equipment from any further damage. In many real-world scenarios, operators need to conduct detailed safety inspections before restarting the production process. Unplanned shutdown inevitably causes loss of production. Additionally, undetected conditions can lead to substandard product quality or even safety breaches.

The present invention seeks to alleviate such problems by providing improved approaches to processing and analysis of sensor data so as to improve detection of normal and abnormal operating states of a process, machine or system.

Accordingly, in a first aspect of the invention, there is provided a method of detecting an operating state of a process, system or machine based on sensor signals from a plurality of sensors, the method comprising: receiving sensor data, the sensor data based on sensor signals from the plurality of sensors; and providing the sensor data as input to a neural network, the neural network comprising: an encoder sub-network arranged to receive the sensor data as input and to generate a context vector based on the sensor data; and a decoder sub-network arranged to receive the context vector as input and to regenerate sensor data corresponding to at least a subset of the sensors based on the context vector. The method preferably further comprises comparing the context vector to at least one context vector classification; detecting an operating state in dependence on the comparison; and outputting a notification indicating the detected operating state.

While in preferred embodiments, the method is computer-implemented (e.g. using software executing on a general purpose computer), some or all of the method could alternatively be implemented in hardware. For example, a hardware implementation of the neural network could be used (e.g. as a dedicated semiconductor device).

Note that the term “regenerate” as used herein preferably indicates that the neural network attempts to (in that it is trained to) reproduce at least a subset of the inputs at the outputs, but the reproduction may and need not be a perfect reproduction—thus the regenerated output signals may represent an approximation of the input signals. An error in the reproduction may be quantified by an error or loss function as described elsewhere herein.

The sensor signals may be real-time sensor signals received from the sensors, and/or the sensor data may be processed in real time using the neural network as the sensor signals are received.

The notification may e.g. be in the form of a visual or audio indication, for example via a control panel, display, speaker, or a fixed terminal or mobile computing device. The notification may also be in the form of an electronic message sent to a device associated with an operator, to an automatic monitoring system (e.g. for logging) or the like.

The operating state may comprise a fault condition. Preferably, the method comprises identifying the fault condition based on a divergence of the context vector from at least one classification associated with a normal operating state or based on membership of the context vector in a predetermined classification associated with the fault condition. Classifications may correspond to context vector clusters. Preferably, the method comprises generating an alert in response to identifying the fault condition, and preferably outputting the alert (e.g. on a control panel or computer) and/or transmitting the alert to an operator device (e.g. as an electronic message).

Preferably, the decoder sub-network is arranged to regenerate sensor data for a selected proper subset of the plurality of sensors. The term “proper subset” is used herein to mean that a first set is a subset of second set, such that the first set contains one or more, but not all, members of the second set. Thus, the decoder sub-network is preferably arranged to regenerate sensor data for one or more (preferably multiple) of the plurality of sensors but not for all of the plurality of sensors. Thus, the encoder sub-network preferably comprises respective inputs for each of the plurality of sensors; and the decoder sub-network comprises respective outputs for a proper subset of the plurality of sensors. The ratio of the number of sensors in the output set to the number of sensors in the input set may be no more than 0.2, preferably no more than 0.1, more preferably no more than 0.05.

The sensors are preferably sensors adapted to measure physical characteristics of, or relating to, the process, system or machine (such as temperature, pressure and the like) and to output signals indicative of the measured characteristics. However, in some cases, sensors may also include devices outputting signals that are indirectly related, or not related, to such physical characteristics. For example, a sensor could output a derived value based on multiple other sensors, a selected operating mode of a device, etc.

The plurality of sensors may comprise sensors associated with measurement of a plurality of distinct physical properties, and wherein the selected subset of sensors are associated with a (proper) subset of the plurality of distinct physical properties or with a single one of the distinct physical properties. Alternatively or additionally, the plurality of sensors may comprise sensors associated with distinct parts or subsystems of the process, system or machine, and wherein the selected subset of sensors are associated with a (proper) subset of, or a single one of, the plurality of distinct parts or subsystems.

Preferably, the method comprises changing the sensor data supplied to the neural network at each of a plurality of time increments, and obtaining from the neural network a respective context vector for each of the time increments. This preferably involves processing sensor data having sensor values associated with timing information, in time order.

Preferably, the encoder subnetwork is adapted to encode sensor data patterns from the plurality of sensors over a predetermined time window. The time window is preferably defined by a plurality of measurement intervals or increments, preferably a plurality of equally spaced time increments.

Advantageously, the encoder sub-network comprises respective sets of inputs for the plurality of sensors for each of a plurality of time increments. The method may then comprise supplying respective input vectors to each set of inputs, each respective input vector associated with a respective sample time and comprising sensor data values for the plurality of sensors corresponding to the respective sample time. The neural network structure may be based on an unrolled recurrent neural network structure, with neurons associated with one time increment connected to neurons associated with a subsequent time increment via one or more weights.

Preferably, each respective set of inputs defines an input channel associated with a respective time increment. The term “input channel” as used here thus preferably denotes a set of sensor inputs for receiving sensor data for a plurality of sensors at a given common measurement/sample time.

The context vector preferably comprises a predetermined number of data values, and wherein the predetermined number is less than the number of input channels multiplied by the number of sensor inputs in each channel. Preferably the number of data values of the context vector is no more than a quarter, preferably no more than a tenth, of the number of input channels multiplied by the number of sensor inputs in each channel

The method preferably comprises, at each time increment, shifting sensor data samples input to the neural network by a predetermined number of input channels, wherein the predetermined number is optionally one. The encoder subnetwork preferably comprises a fixed number of input channels and wherein shifting sensor data samples comprises dropping samples of a channel corresponding to a least recent time increment, shifting sensor data samples from the remaining input channels by one input channel, and supplying new sensor data samples to an input channel corresponding to a most recent time increment. Thus, inputs to the neural network are preferably obtained based on a sliding a time window (with a width corresponding to the number of time increments for which there are input channels) with respect to the temporally ordered sensor data.

Preferably, the decoder subnetwork comprises a predetermined number of output channels each associated with a respective time increment and comprising outputs for respective regenerated sensor signals, optionally wherein the number of input channels of the encoder subnetwork is equal to the number of output channels of the decoder subnetwork. Thus, the regenerated sensor signals preferably correspond to a time window having a corresponding set of time increments to the input signals.

Preferably, the method comprises training the neural network using a training set of sensor data from the plurality of sensors, wherein training the neural network preferably comprises using an error function quantifying an error in the regenerated sensor data to adjust weights in one or both of the encoder sub-network and the decoder sub-network. Preferably, backpropagation is applied through both the decoder and encoder networks based on the error function to train the network.

The neural network is preferably trained until a termination criterion is met, the termination criterion preferably comprising the change in the value of the error function remaining below a threshold, or no change in the value of the error function occurring, over a predetermined number of iterations, wherein each iteration (“epoch”) comprises training the neural network using the training data set (preferably using the complete training set on each iteration).

The neural network is preferably trained (e.g. in a given epoch) on a sequence of training samples, each training sample comprising a set of input vectors corresponding to a plurality of respective time increments, the method preferably comprising selecting a given training sample from a temporally ordered training set of input vectors by shifting a selection window by a predetermined number of time increments (preferably one). In other words, training samples preferably overlap temporally, with each subsequent training sample preferably including some of the sensor data of a previous training sample.

After training the neural network (e.g. after the termination criterion is met and training has ceased), the method preferably comprises applying the neural network to a training set of sensor data, the training set optionally the same as or a different from the training data set used to train the neural network, to generate a plurality of context vectors; and determining the at least one context vector classification based on the context vectors. This may involve applying a supervised or unsupervised classification algorithm to learn classifications of the context vectors.

Preferably, classification is based on clustering. Thus, determining at least one context vector classification may comprise performing a clustering on the context vectors to identify one or more clusters of the context vectors, and optionally assigning a classification to one or more of (optionally each of) the identified clusters. Assigning classifications to identified clusters may comprise training a classifier based on the identified clusters. The classifier may assign a classification to each of the clusters (or only to some of the clusters). Classification of an unseen context vector may occur by applying the trained classifier to the unseen context vector, by determining cluster membership based on a vector distance measure, or in any other appropriate way.

Accordingly, the at least one context vector classification preferably comprises (or corresponds to) one or more context vector clusters, and detecting an operating condition may then comprise determining at least one of: a membership of the context vector in one of the identified clusters; one or more distances of the context vector from one or more respective ones of the identified clusters.

Preferably, identifying an operating condition comprises detecting an abnormal operating condition (e.g. a fault condition) based on the context vector not matching one of the identified classifications or clusters and/or based on a distance of the context vector to a nearest identified cluster exceeding a threshold distance.

Alternatively or additionally, identifying an operating condition may comprise detecting an operating state transition by detecting a change in classifications of generated context vectors over time, for example by detecting a change of a context vector output by the neural network from a first cluster or classification to a second cluster or classification.

The method may comprise pre-processing the sensor signal data to generate sets of sensor data for each sensor having the same temporal resolution. This may involve subsampling the sensor data and/or summarising sensor data for one or more sensors by generating a representative sensor value for each of a set of successive time intervals, preferably wherein generating a representative sensor value comprises determining an average, median or last data value for the time interval.

The method may comprise training a plurality of neural networks having different input sensor sets and/or different output sensor sets. Multiple trained networks may be applied to the same sensor data during real-time monitoring.

The neural network preferably comprises a sequence-to-sequence model, preferably in the form of a sequence-to-sequence autoencoder, and is preferably based on a recurrent neural network architecture. The neural network thus preferably comprises recurrent neurons, preferably long short term memory, LSTM, neurons.

The process, system or machine optionally comprises a pressure control system for modifying the pressure of a fluid (e.g. gas or liquid). The sensor signals provided as input to the neural network may then be based on sensors for measuring one or more of: pressure, temperature, and vibration. The regenerated output sensor signals may be for one or more pressure sensors.

Alternatively, the process, system or machine may comprise a heating, ventilation and/or air-conditioning, HVAC, system (the term HVAC system refers to any system providing any or all of the indicated functions, e.g. the HVAC system could simply be heating system without the other functions).

In a further aspect, the invention provides a tangible computer-readable medium comprising software code adapted, when executed on a data processing apparatus, to perform any method as set out herein. The invention also provides a system, apparatus or computer device having means, preferably in the form of a processor and associated memory, for performing any method as set out herein. The system may include the plurality of sensors and/or a computer device for performing the processing functions.

Any feature in one aspect of the invention may be applied to other aspects of the invention, in any appropriate combination. In particular, method aspects may be applied to apparatus and computer program aspects, and vice versa.

Furthermore, features implemented in hardware may generally be implemented in software, and vice versa. Any reference to software and hardware features herein should be construed accordingly.

Preferred features of the present invention will now be described, purely by way of example, with reference to the accompanying drawings, in which:

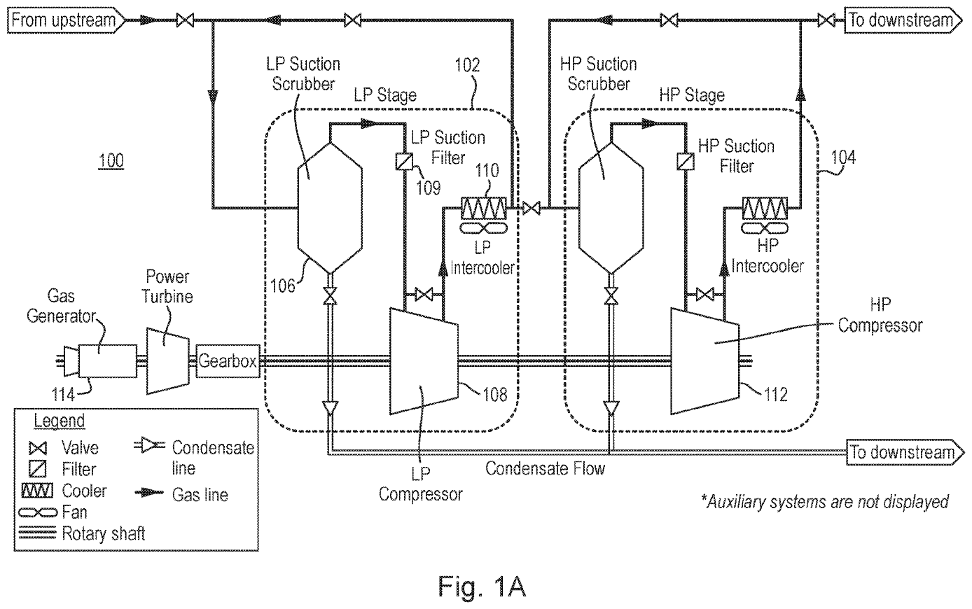

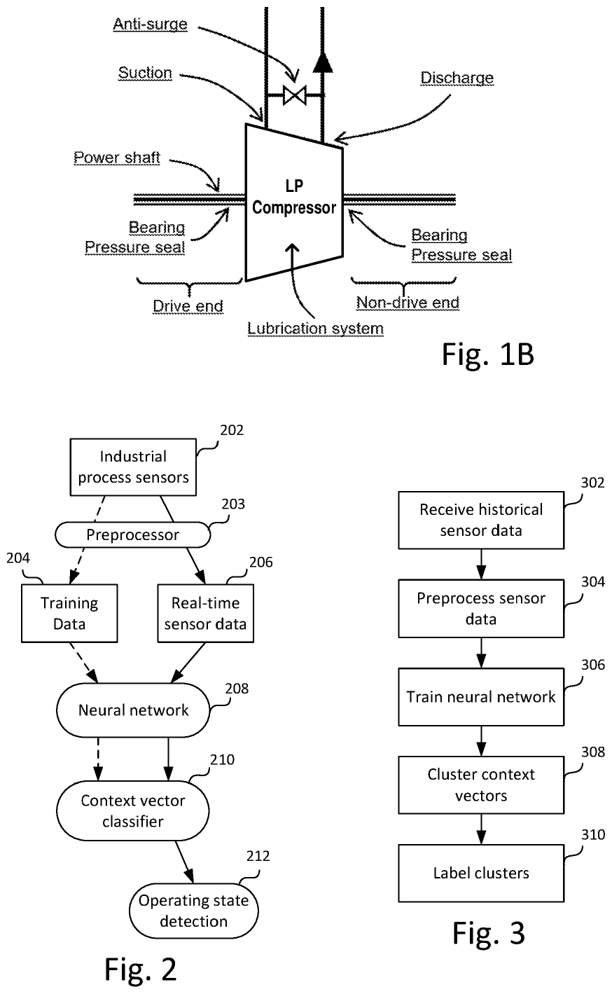

FIG. 1A is a simplified process diagram showing a two-stage gas compression train;

FIG. 1B illustrates a part of the gas compression train in more detail;

FIG. 2 illustrates components of a system for analysing sensor data in accordance with embodiments of the invention;

FIG. 3 illustrates a process for training a neural network and associated classifier;

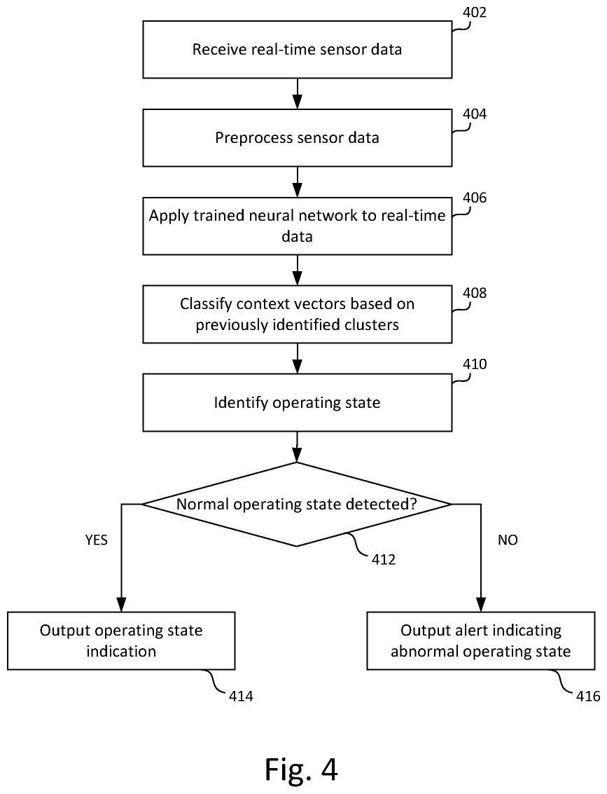

FIG. 4 illustrates a process for applying the trained neural network and classifier to real-time sensor data;

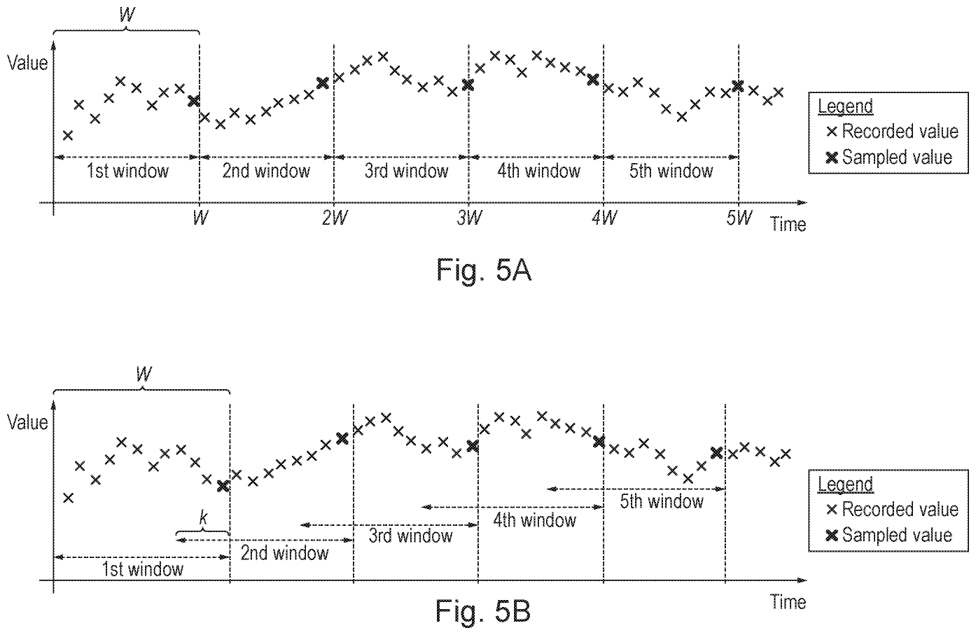

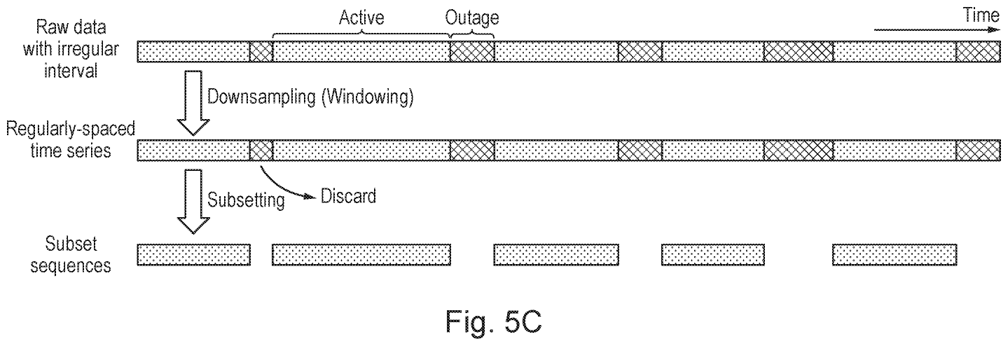

FIGS. 5A, 5B and 5C illustrate pre-processing of sensor data, including sampling of the sensor data based on tumbling or sliding time windows;

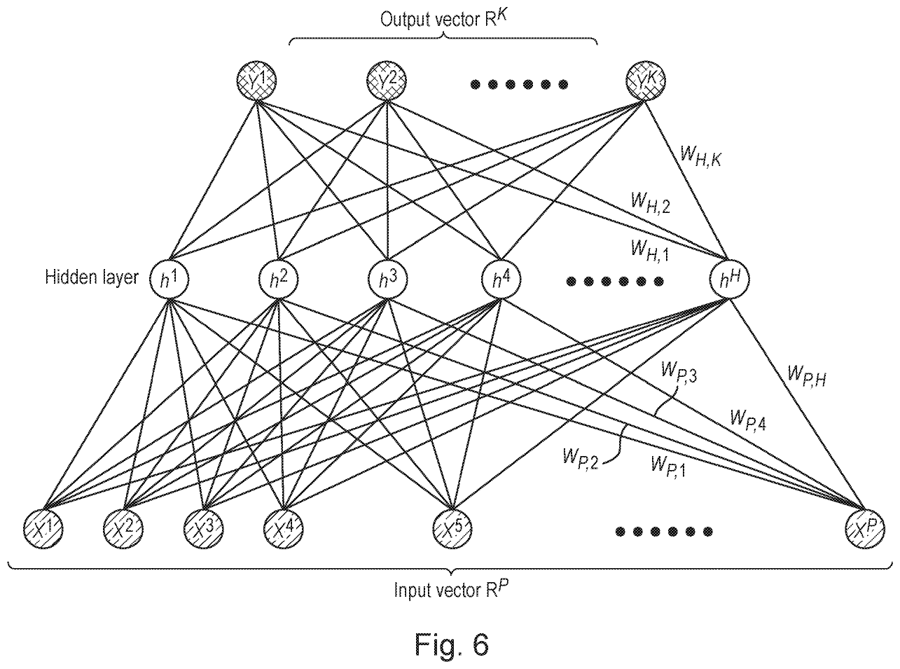

FIG. 6 illustrates an example of a feed-forward neural network;

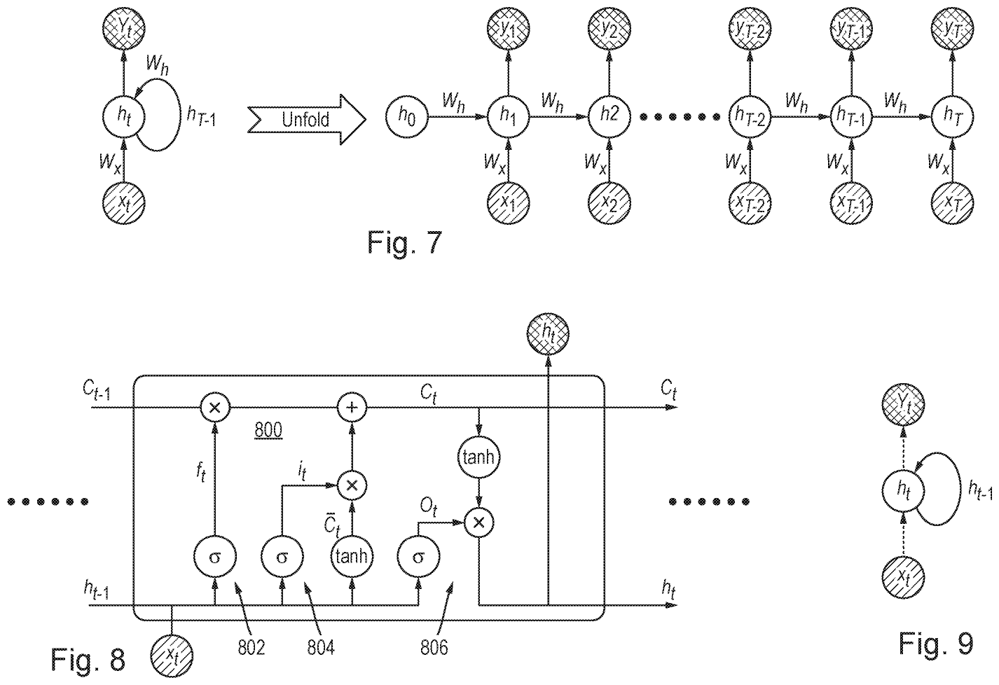

FIG. 7 illustrates unfolding of a recurrent neural network (RNN) into a forward-feeding deep neural network;

FIG. 8 illustrates the internal structure of a long short-term memory block (LSTM), for use as a neuron unit in described neural networks;

FIG. 9 illustrates the application of dropout in an RNN;

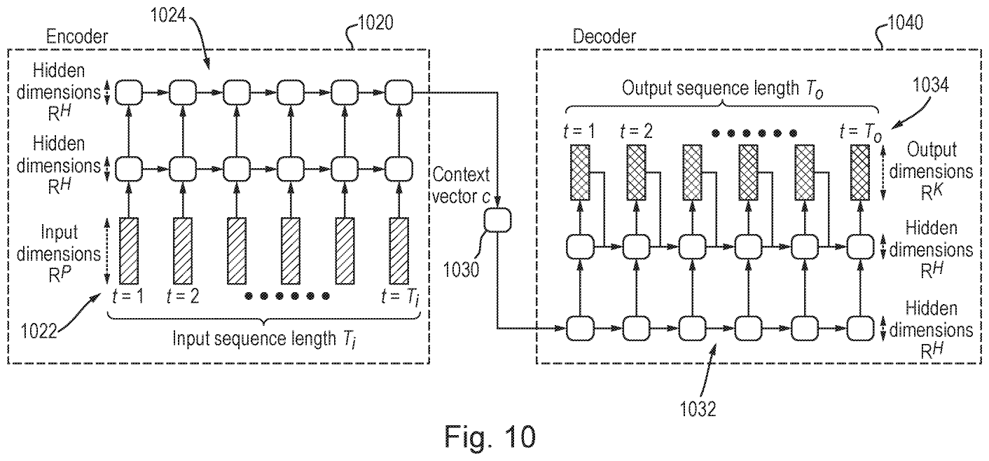

FIG. 10 illustrates the architecture of a sequence-to-sequence neural network model with multiple hidden recurrent layers, with encoder and decoder subnetworks made up of multi-layered RNNs;

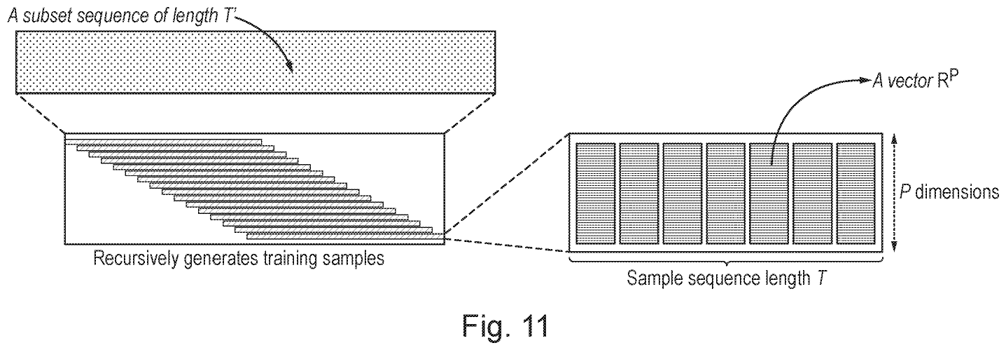

FIG. 11 illustrates generation of training samples from input sensor data;

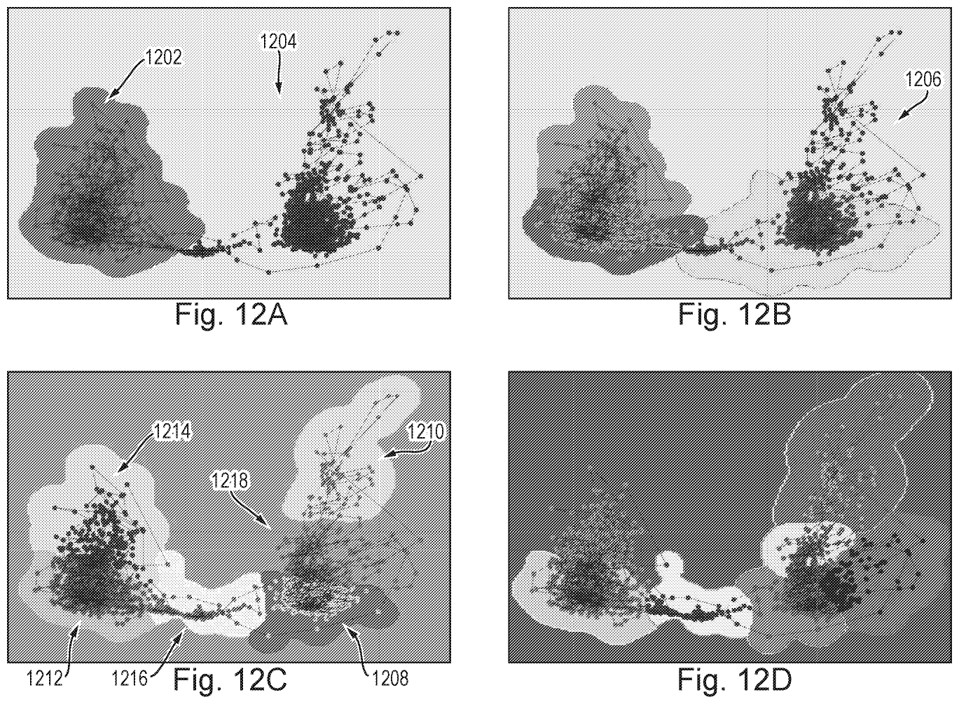

FIGS. 12A-12D illustrate clustering of context vectors;

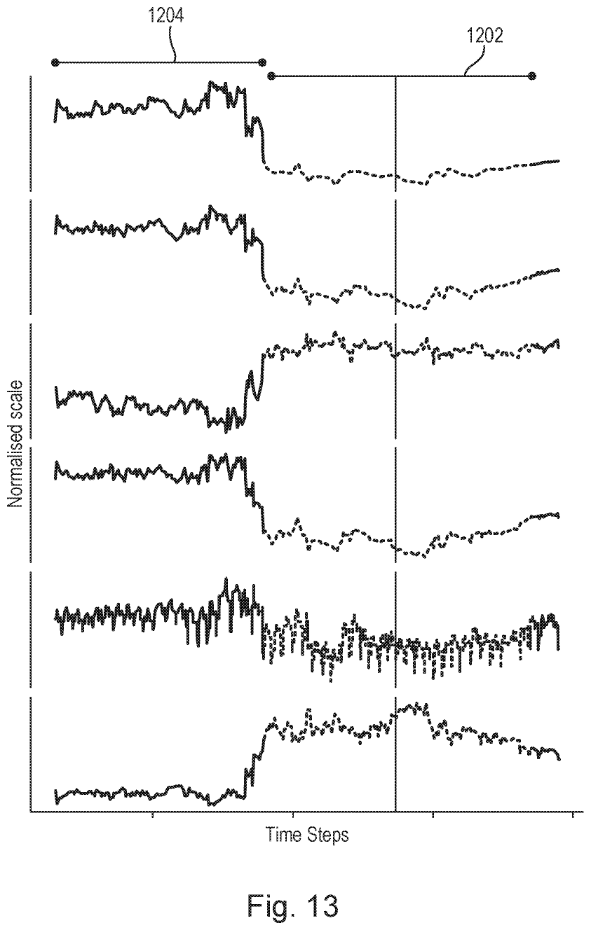

FIG. 13 illustrates output dimensions of the neural network, visualised on a shared time axis;

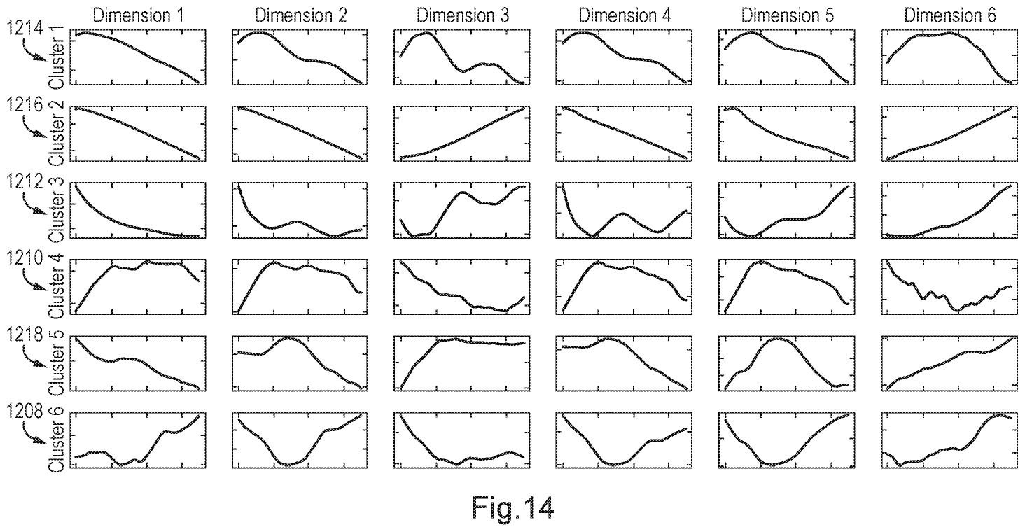

FIG. 14 illustrates mean values of each dimension of a 6 cluster scenario;

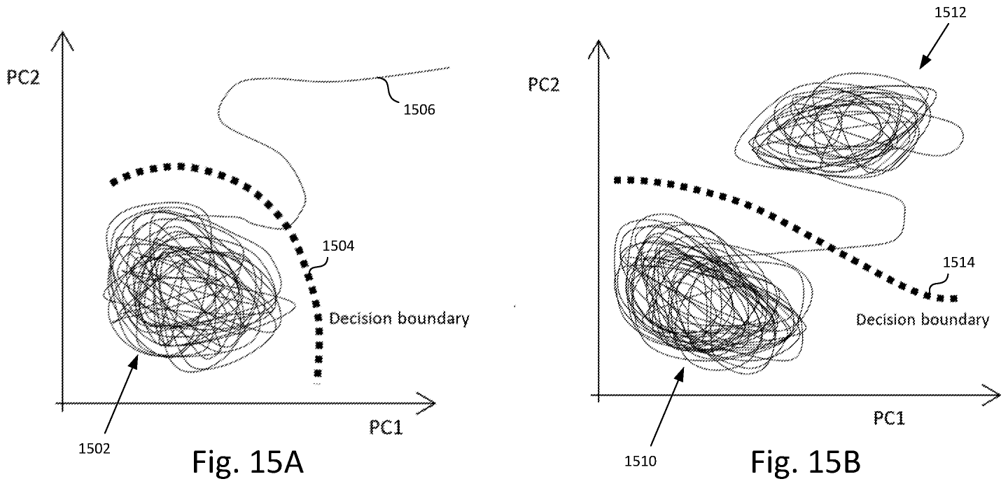

FIGS. 15A and 15B illustrate the relationship between the travelling context vector and classifications of process state, as defined by context vector clusters and associated decision boundaries;

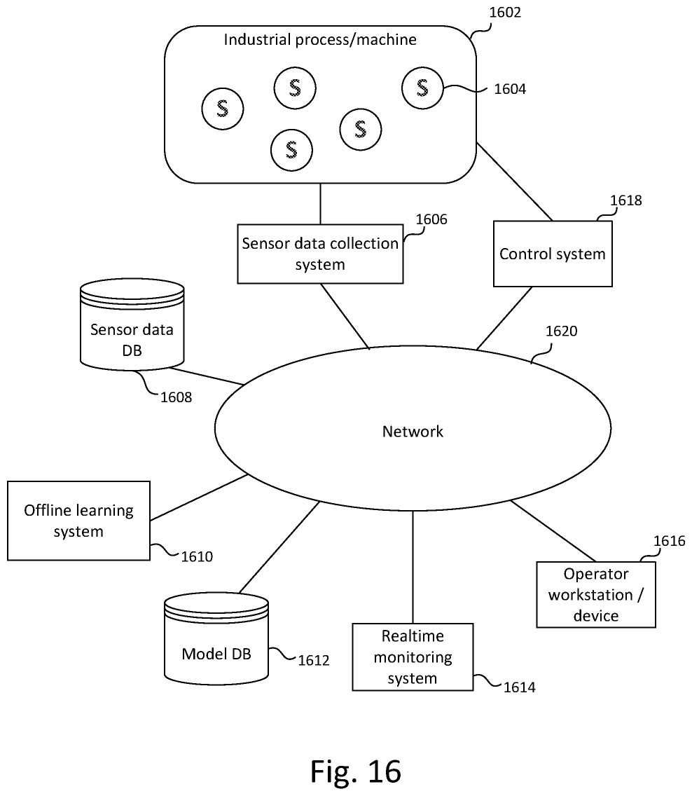

FIG. 16 is a schematic illustration of a computer system for implementing described methods for sensor data analysis; and

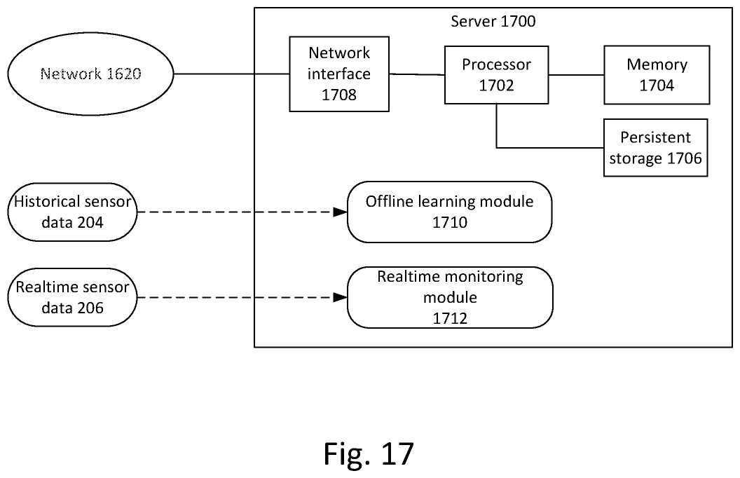

FIG. 17 illustrates hardware and software components of a processing device for performing disclosed methods.

### OVERVIEW

Embodiments of the present invention use machine learning approaches based on artificial neural networks to capture complex temporal patterns across multiple sensors. To achieve this, a sequence-to-sequence model is modified into an autoencoder by aligning the input and output sequences. The model's encoder summarises the input into a vector which can be used to represent meaningful features of the signal data. When consecutively drawn samples are fed to the model, the summary information varies in a way which reflects the change in complex temporal patterns. This information can be analysed further by applying visualisation and clustering techniques.

The described machine learning techniques can be used to analyse signal data in an on-line (i.e. real-time) scenario. The neural network algorithms can be used to handle real-time streams of sensor measurements natively and learn complex patterns intelligently over time. Using a large-scale gas production process as an example, it is found that the proposed approach can generate meaningful diagnostic measurements using real-time sensor data. These measurements can then be used to identify abnormal patterns or substantial change in the underlying process state, thus enabling operators to anticipate and mitigate problems.

While described embodiments apply the techniques to a dataset collected from an industrial scale two-stage compression train, the proposed method can be generalised to signal analysis problems for any multi-sensor multi-state processes.

### APPLICATION EXAMPLE

The application for the described embodiments is centred on a two-stage gas compression train at a natural gas terminal. The compression train receives unprocessed gas from an offshore platform via a subsurface pipeline. The incoming gas reaches the compressor at a variable, naturally-occurring pressure. This implies that the gas pressure needs to be regulated and increased to an appropriate level before feeding it to other downstream processes. A simplified process diagram showing a two-stage gas compression train is illustrated in FIG. 1A.

The compression train uses two centrifugal compressors 108, 112 connected in series to raise the gas pressure in separate stages. At first, the incoming gas flows through a suction scrubber 106 to remove condensate in the Low Pressure (LP) stage 102. Dry gas exits the scrubber through the top outlet and passes through a gas filter 109. The LP compressor 108 receives gas through the suction inlet and raises the gas pressure to an intermediate level. The compressed gas from LP stage leaves via the discharge outlet and the temperature is reduced at the intercooler 110 afterwards. Gas then goes through the High Pressure (HP) stage 104 which raises the pressure further to a higher level through a similar configuration. Both LP and HP stages are driven by an aeroderivative gas generator 114 on a single shaft.

Sensors are attached to various parts of the compression train to monitor the production process. Vital statistics like temperature, pressure, rotary speed, vibration etc., are recorded at different locations. FIG. 1B is a more detailed diagram showing certain sensor locations at the LP compressor, by way of example. Several key components of the compression train are vulnerable to tripping. For example, lack of lubrication would cause high vibration which eventually trips the entire compression train, leading to shutdown. Alternatively, discharging gas at unstable pressure may risk damaging downstream equipment, etc.

As previously mentioned, a simple rule-based system can be used to highlight issues (e.g. thresholding) in a production process. However, complex patterns over time are hard to describe explicitly especially when it involves a group of sensors. In the proposed approach to diagnostic measurement this problem is addressed by considering the whole process state as a multidimensional entity which varies over time.

In this approach, each stream of sensor measurements is treated as a set of real values IR received in a time-ordered fashion. When this concept is extended to a process with P sensors, the process can therefore be expressed as a time-ordered multidimensional vector {Rₜ^{P}: t ∈[1,T]}.

Embodiments of the invention provide a system for analysing sensor signals which uses neural networks to handle the high-dimensional data natively as will be described in more detail below. The aim is to use these techniques to analyse multidimensional time series data and understand changes of the underlying process state. Warnings can be triggered by process state transition or if substantial deviation is observed. Although the discussion of the proposed approach is focused on the natural gas terminal use case, it can be further extended to any multi-sensor multi-state processes or machines.

A sensor data analysis system in accordance with an embodiment is illustrated in overview in FIG. 2. The system comprises a set of industrial process sensors 202 which provide the raw sensor data input. The sensors may, e.g. by part of a system such as depicted in FIG. 1A, and may include any type of sensors appropriate to the process or machine being monitored, including, for example, temperature sensors, pressure sensors, flow sensors, vibration sensors, humidity sensors, electrical sensors such as voltage/current meters, chemical sensors, optical or other electromagnetic radiation sensors, audio sensors, etc. Sensors could also include complex/abstracted sensing devices, e.g. that generate a composite sensor output based on inputs from multiple physical sensor devices.

The raw sensor data may be pre-processed by a pre-processor 203 if needed, for example to generate sensor data streams with a consistent temporal resolution appropriate to the subsequent analysis. Alternatively or in addition, the pre-processor 203 may be provided to modify or adjust the raw sensor data using a mathematical analysis or algorithm or other processing to provide sensor data values appropriate to the subsequent analysis.

Processing is divided into two distinct phases: a training phase (indicated by dashed arrows) involves training a neural network 208 and context vector classifier 210 based on a set of training data 204. A real-time monitoring phase (represented by solid arrows) involves applying real-time sensor data 206 to the trained neural network and context vector classifier to determine an operating state 212 of the monitored process or machine.

The training phase is illustrated in more detail in FIG. 3. With reference to both FIGS. 2 and 3, in the training phase, a set of historical sensor data is collected from the sensors in step 302. This may be collected directly over a given time period or may be obtained from a database of historical sensor data. The sensor data is pre-processed in step 304, to form the training data set 204. In step 306, the training data is used to train neural network 208.

The neural network is a sequence-to-sequence autoencoder which is arranged to take the training data as input and generate a multi-value vector representing a summarisation of the input sensor data. The vector is referred to herein as the context vector. The context vector thus provides a summary of the operating state of the industrial process or machine at a given time. However, as explained in more detail later, in a preferred embodiment, the neural network operates not on an instantaneous set of samples from the input sensors, but on sensor readings for the sensors over a specified time window, and thus the context vector includes a temporal dimension in its summary of the process state.

Context vectors generated by the neural network based on training data are provided to train the context vector classifier 210. This involves clustering of context vectors (step 308) to determine a set of context vector clusters representing different classifications of the system operating state. The clusters may be labelled (e.g. by an expert, or automatically based on prior knowledge of operating states associated with the historical sensor data) in step 310 to specify the type of operating state each cluster represents (e.g. “normal operation”, “system failure” etc.)

The real-time monitoring phase is illustrated in more detail in FIG. 4. Referring to FIGS. 2 and 4, the real-time sensor data is acquired in step 402 and optionally pre-processed in step 404. The (pre-processed) sensor data is then input to the trained neural network in step 406, which generates context vectors based on the real-time data. The context vectors are then classified (where possible) by the context vector classifier in step 408 and an operating state is identified based on the output of the classifier in step 410. This may involve assigning a known classification (cluster membership) to a context vector, representing a known operating state (whether normal or abnormal/faulty) and/or detecting a divergence from known classifications, representing a possible abnormal/failure state. The system then outputs the result of the operating state detection. This may involve a determination as to whether the detected operating state corresponds to a normal operating step in step 412, and if so, outputting an indication of the operating state in step 414. In case the operating state is an abnormal or divergent state, an operator alert may alternatively be generated and output in step 416.

Output of the operating state indication and/or abnormal state indication/alert (steps 414, 416) may occur via a control panel associated with the process/machine (e.g. using indicator lights or a digital display), via an operator computer terminal displaying process diagnostics, via electronic messages to an operator device (e.g. email/instant message to an operator smartphone or table computer), or in any other appropriate way.

Additionally, the system could implement automatic control actions in response to specific detected operating states, for example altering one or more control parameters for the process or machine or initiating an automatic shutdown. Different notification or control actions could be implemented based on the detected operating state. For example, certain states (even abnormal ones) may merely produce a notification via a suitable device or interface, whilst others (e.g. critical failure states) could trigger automated process controlshutdown actions.

Implementation Details

The following sections describe in more detail implementations of the processes and algorithms employed in certain embodiments of the invention, including the data pre-processor, neural network and context vector classifier.

Sensor Data Pre-Processor

In preferred embodiments, streams of sensor measurements from the sensors are recorded in a database system continuously. To obtain the training data, the system performs a batch extract of sensor readings for all sensors (e.g. as a collection of comma-separated text files). During online monitoring, the real-time sensor data may similarly be read from the database after it has been recorded or may be received directly from the sensors. In both cases, pre-processing may be performed as needed, as described in the following sections.

Down-Sampling

In a typical system, the raw sensor data is recorded continuously at very granular level. In the described application example, the interval between records can typically range between 1 to 10 seconds depending on the process configuration at the time. Shorter time intervals give a more detailed view of the process. However, problems arise when successive sensor values are not guaranteed to have a fixed interval between them. Although time series analysis accepts time-order data, it may require successive observations to be separated by equal time intervals. To achieve this, the raw sensor dataset may be standardised in order to create equally-spaced data for further analysis.

Preferred embodiments use a windowing approach to convert high-frequency data with irregular intervals into equally-spaced time series. Through this pre-processing step, the size of the data is reduced and this is therefore a form of down-sampling.

In one embodiment, a tumbling time window is used to down-sample the raw data. This involves applying a tumbling time window along the timeline of the raw data.

Windows of equal sizes are imposed successively without any gap or overlapping in between. For any given window of size W, a sampling function evaluates all the member vectors and returns a single vector as the representative sample of the current window. Commonly used sampling functions include simple arithmetic averaging, taking a median value, or returning the last member (i.e. sorting all the input vectors chronologically and returning the most recent).

FIG. 5A offers a graphical illustration of a tumbling time window approach which returns the last value within any given time window.

In another embodiment, the raw data is downsampled using a sliding time window approach. This can be viewed as a special case of the tumbling windows approach where overlapping between successive time windows is allowed. The parameter W determines the window size, while the overlapping size is controlled by a parameter k. Once the windows are established, a sampling function is applied to all member vectors of the window and one representative vector is returned as the downsampled sequence. This is illustrated in FIG. 5B. The sampling function may be any appropriate sampling function, including any of those mentioned above in relation to the tumbling time window approach (e.g. mean/medium/most recent etc.)

Once the downsampled data is prepared, successive sensor records will have equal time intervals in between them. However, it is possible that the production process may suffer outages despite valid sensor readings still being continuously recorded. Besides, the production equipment may have been reconfigured or modified during downtime. In light of this, data recorded over known outage periods are discarded from the training dataset. In addition, short periods may be discarded from the dataset as they often indicate safety testing rather than actual production processes.

FIG. 5C summarises the down-sampling and subsetting pre-processing stages, illustrating how raw sensor measurements are standardised into regularly-spaced time series data using either described windowing approach, and afterwards, known outage periods are discarded from the dataset.

Neural Network Implementation

Artificial neural networks (ANN) are machine learning algorithms inspired by biological neurons. An ANN consists of a collection of artificial neurons arranged in one or more layers in which each neuron computes the weighted sum of its inputs and decides based on the computed value whether to fire.

FIG. 6 provides an illustration of a forward-feeding artificial neural network (FNN) with one hidden layer. The network receives an input vector R^{P} through an input layer of P neurons and learns the output vector R^{K} (i.e. the ANN performs a vector mapping function f: R^{P}→R^{K}). In this example, the ANN has a single hidden layer of H neurons. Each h^{th} neuron where h=1, . . . ,H applies a weight W_{p,h} on the p^{th} input dimension of the vector R^{P} where p∈1, 2, 3, . . . ,P and the weighted sum of input is adjusted with a bias bₕ as shown in equation (Eqn 1). The bias-adjusted weighted input xₕ then feeds through a non-linear function in a process called activation (Eqn 2).

Weighted sum and bias adjustment:

$${x}_{h} = {b}_{h} + {\sum }_{p = 1}^{P} {w}_{p , h} {X}_{p} , h = 1 , … , H \qquad ( Eqn 1 )$$

Activation:

hₕ=f(xₕ), h=1, . . . , H (Eqn 2)

ANNs with information flowing in one direction (i.e. without loops) are called forward-feeding neural networks (FNN). This topology can be extended to multiple hidden layers, thus forming a multilayer perceptron (MLP) network.

The objective of traditional ANNs is to map an input vector to an output vector through non-linear modelling. Ordering of the observations is immaterial in the sense that the models can effectively preserve the same properties even if the training data is randomly shuffled. However, this usually makes ANNs unsuitable to handle problems with temporal dependencies as they do not take into account time.

Embodiments of the invention are therefore based on the principle of recurrent neural networks (RNN), which can be applied to time-ordered data. Similar to the basic ANN, recurrent neurons process incoming information through non-linear activation functions. However, in this case, the data is presented to the model sequentially by time order and the neurons' output is passed on to the immediate next time step. Thus, RNNs introduce an extra feedback loop at each recurrent neuron.

Thus, RNN topologies contain multiple recurrent neurons, commonly arranged in stacked layers. In one example (referred to as an Elman network), a multilayer network may be used with recurrent neurons in the hidden layer. The hidden state of the recurrent neuron hₜ is updated using the current input xₜ as well as previous information at t−1. This means that the recurrent neurons can carry over knowledge from the past (Eqn 3a). In another similar model (referred to as a Jordan network), the network output yₜ₋₁ is presented to the hidden layer in the next time step (Eqn 3b). These RNNs can map a sequence of inputs to an output effectively by remembering previous information.

Elman network:

hₜ=f(hₜ₋₁, xₜ) (Eqn 3a)

Jordan network:

hₜ=f(y_{t-1,} xₜ) (Eqn 3b)

Either approach may be used in embodiments of the invention. Although RNNs have characteristic feedback loops which span over time, they can still be trained using gradient-based methods. Described embodiments employ an approach based on the backpropagation through time (BPTT) algorithm, which involves removing the loops by unfolding the RNN into an FNN. This transforms a RNN with T steps into a forward feeding ANN with T layers.

This unfolding is illustrated in FIG. 7, where the weight connecting hidden state hₜ and hₜ₋₁ is denoted as wₕ which is shared throughout the entire network. Similarly, the weight connecting input xₜ and xₜ₋₁ is denoted as wₓ and is also shared across all time steps. At the beginning of the unfolded network, an extra zero-padded vector is appended as hidden state h₀. Once the network is free from any feedback loops, it can be treated as forward-feeding network and therefore trained using a backpropagation algorithm.

The first stage of the backpropagation algorithm (forward propagation) calculates the network output using the current model weights. The principle can be illustrated using a typical Elman network with H neurons arranged in a single hidden layer, P input dimensions and K output dimensions. The output of the h^{th} hidden recurrent neuron at time y is denoted as hₕ^{t}. The weighted sum of all input dimensions at the current time step is added to the weighted sum of hidden activations at the previous step and a shared bias (Eqn 4a). The value is then activated through a non-linear activation function (Eqn 4b).

Forward propagation:

$$\begin{matrix}{x}_{t}^{h} = {b}^{h} + {\sum }_{p = 1}^{P} {w}_{p , h} {x}_{t}^{p} + {\sum }_{{h}^{′} = 1}^{H} {w}_{{h}^{′} , h} {h}_{t - 1}^{{h}^{′}} & ( Eqn 4 a ) \\ {h}_{t}^{h} = f ( {x}_{t}^{h} ) & ( Eqn 4 b )\end{matrix}$$

The activated output hₜ^{h} is iteratively calculated for each neuron by incrementing time step t=1, 2, 3, . . . , T. Once all hidden outputs have been calculated for all the H hidden neurons, the network output Ŷₜ^{k} of the k^{th} dimension at time t is simply the weighted sum of all hidden activations at the same time step for a regression problem. Using the forward propagation algorithm, the network output can be calculated at every time step.

During the weight update stage of the algorithm, the model's output is compared with the expected output (i.e. training labels) in order to calculate the loss L with respect to the current set of parameters. The loss function is a hyperparameter of the ANN. For regression problems, commonly-used loss functions include mean-squared error (MSE), mean absolute percentage error (MAPE) and mean absolute error (MAE), any of which (or other suitable loss functions) may be used in embodiments of the invention.

Network output and loss function:

$$\begin{matrix}{\hat{Y}}_{t}^{k} = {\sum }_{{h}^{′} = 1}^{H} {w}_{{h}^{′} , k} {h}_{t}^{{h}^{′}} & ( Eqn 5 a ) \\ {ℒ}_{w} = f ( {\hat{Y}}^{t} , {T}^{t} ) & ( Eqn 5 b )\end{matrix}$$

In this stage, the algorithm tries to improve the loss function by modifying the weights. To achieve this, partial derivatives are applied to the loss function to find out the gradients with respect to each weight. In RNNs, this step is very similar to regular weight update in simple ANNs. The only exception is that the gradient depends on both the output as well as the information inherited from the previous time step. For example, the gradient of the h^{th} hidden neuron is given by the following formulae where all of the K outputs and H hidden neurons are involved.

The gradient is iteratively calculated backwards, starting from t=T until it reaches the beginning of the sequence. The gradient with respect to each of the weights is calculated as the sum of the whole sequence over time. The weights are then updated iteratively and the backpropagation process starts again.

Network output and loss function:

$$\begin{matrix}{δ}_{t}^{h} = \frac{\partial L}{\partial {h}_{t}^{h}} & ( Eqn 6 a ) \\ {δ}_{t}^{h} = f ( {h}_{t}^{h} ) ( {\sum }_{k = 1}^{K} {δ}_{k}^{t} {w}_{h , k} + {\sum }_{{h}^{′} = 1}^{H} {δ}_{{h}^{′}}^{t + 1} {w}_{h , {h}^{′}} ) & ( Eqn 6 b )\end{matrix}$$

Common activation functions such as sigmoid and hyperbolic tangent squeeze the input space into a very small and fixed range. If the network is very deep (e.g. an unrolled RNN with long sequence), the activation of earlier layers would be mapped to an even smaller range in later layers. This means that large changes in earlier layers would cause insignificant changes in later layers. As a result, the gradient in earlier layers would be unavoidably small. Recalling the core principle of backpropagation, this would typically result in slow learning in layers with weak gradients. This leads to the vanishing gradient problem which can be problematic for deep ANNs as well as RNNs with long training sequences.

The opposite of vanishing gradient is the exploding gradient problem, which occurs in a deep network when the gradients are large, as the multiple of many positive values yields a very large number. In some extreme cases, the weight update step can fail as the new weights exceed the precision range. Such problem can be mitigated by weight clipping.

Unstable gradients can be avoided by using alternative activation functions which do not forcibly squeeze input space into a narrow range. For instance, rectifier activation (e.g. ReLU) can provide a robust gradient over any positive range. Another way to avoid the unstable gradient problem is to use different recurrent neuron structures which will be discussed in the next section.

Long Short-Term Memory

As simple RNNs suffer from unstable gradient problems, they are often ineffective in learning long term dependencies. Preferred embodiments of the invention address this by using a neuron structure referred to as long short-term memory (LSTM).

Like a simple recurrent neuron, the LSTM block aims at learning patterns over time by carrying information from previous time steps. However, the LSTM block structure is more complicated and includes multiple gates controlling the flow of information, as illustrated in FIG. 8 (adapted from C. Olah, “Understanding LSTM Networks”, http://colah.github.io/posts/2015-08-Understanding-LSTMs/).

Each LSTM block 800 carries a hidden state denoted as Cₜ which holds the recurrent information. It is updated by identifying what needs to be forgotten and what needs to be remembered, given the current input xₜ and the activation at previous step hₜ₋₁.

The forget gate 802 on the leftmost side contains a sigmoid function. It reads the information and computes a real value (0, 1) which indicates the portion of information to forget (i.e. closer to 0) or to retain (i.e. closer to 1) (Eqn 7a).

Similar to the forget gate, another sigmoid function called the input gate 804 determines the amount of information to remember at the current time step which is denoted as iₜ. The input gate is also computed using the current input xₜ and previous steps output hₜ₋₁ but with a different weight vector (Eqn 7b). Then a hyperbolic tangent function yields a real value (−1, 1) to decide how much to update (Eqn 7c).

Lastly, the new hidden state Cₜ can be updated by multiplying the forget gate value fₜ with the previous hidden state of the neuron Cₜ₋₁, then adding the input gate value iₜ scaled with the hyperbolic tangent function output \tilde{C}ₜ (Eqn 7d).

Simultaneously, the output gate 806 is computed with a sigmoid function using the same parameters xₜ and hₜ₋₁ (Eqn 7e). Meanwhile the updated hidden state Cₜ goes through a hyperbolic tangent function to decide the portion of information to output. These two parts multiply together to form the recurrent output hₜ of the current time step (Eqn 7f).

Forget gate:

fₜ=σ(W_{f}[hₜ₋, xₜ]+b_{f}) (Eqn 7a)

Input gate:

iₜ=σ(Wᵢ[hₜ₋₁, xₜ]+bᵢ) (Eqn 7b)

\tilde{C}ₜ=tanh(W_{c}[hₜ₋₁, xₜ]+bᵢ) (Eqn 7c)

Update hidden state:

Cₜ=fₜ×Cₜ₋₁+iₜ×\tilde{C}ₜ (Eqn 7d)

Output gate:

Oₜ=σ(Wₒ[hₜ₋₁, xₜ]+bₒ) (Eqn 7e)

hₜ=Oₜ×tanh Cₜ (Eqn 7f)

As the LSTM block uses various gates to control information flow, recurrent information can be carried over to further down the time line as it is protected from being overwritten. For example, the recurrent hidden state Cₜ cannot be overwritten by the current input xₜ if the input gate is not open (i.e. the \tilde{C}ₜ value is close to zero). This allows the LSTM block to avoid unstable gradients and can therefore enable learning of long-term temporal dependencies over multiple steps.

ANN's non-linear capability implies that it is a very flexible modelling technique which is prone to overfitting. To overcome this problem, embodiments may employ an approach whereby a randomly selected fraction of neurons are temporarily removed during training. This technique is referred to as dropout and forces the neurons to work with the remaining network more robustly and hence prevents overfitting. In an

RNN setting, dropout can amplify error when applied to recurrent connections. One approach is to apply dropout only to non-recurrent connections (e.g. between hidden layers). This helps the recurrent neurons to retain memory through time while still allowing the non-recurrent connections to benefit from regularisation. Application of dropout in an RNN is illustrated in FIG. 9, where dotted arrows indicate non-recurrent connections where dropout is applied, and the solid arrow indicates a recurrent connection without dropout.

Sequence-to-Sequence Model

Embodiments of the invention employ an RNN using LSTM nodes as neurons based on the principles described above to create a sequence-to-sequence (seq2seq) model. A seq2seq model is a type of RNN model which has an encoder-decoder structure where both are made up of multi-layered recurrent neurons. The purpose of a seq2seq model is to provide an end-to-end mapping between an ordered multidimensional input sequence and its matching output sequence. Such models have conventionally been applied to solve machine translation and other linguistic tasks. However, present embodiments extend these techniques to allow them to be applied to the sensor data analysis problem.

As discussed above, a large-scale industrial process with sensor data collected at various locations can be treated as a multidimensional entity changing through time. By extending seq2seq models to the area of signal processing the power of recurrent neurons to understand complex and time-dependent relationships can be leveraged.

FIG. 10 graphically illustrates a seq2seq neural network architecture in accordance with an embodiment of the invention (arrows indicate the direction of principal information flow; feedback by backpropagation is not explicitly indicated). The model consists of an encoder subnetwork 1020 and a decoder subnetwork 1040, with multiple hidden recurrent layers. The encoder 1020 reads an input sequence 1022 and summarises all information into a fixed-length vector 1030 at the context layer. The decoder then reads the context vector 1030 and predicts the target sequence 1034. Both the encoder and decoder are made up of multi-layered RNN.

Encoder

The role of the recurrent encoder is to project the multidimensional input sequence 1022 into a fixed-length hidden context vector c (1030). The encoder reads the input vector of R^{P} dimensions sequentially from t=1,2,3, . . . ,Tᵢ where the input sequence contains Tᵢ time steps. The hidden state of the RNN, made up of R^{H} dimensions, updates at every time step based on the current input and hidden state inherited from the previous step (Eqn 8a). The input sequence length Tᵢ is fixed during training and prediction as well. This allows the model to capture temporal patterns at maximum length Tᵢ.

The dimension of the input sequence is also fixed for training and prediction. In order to leverage the RNN encoder's power to learn complex patterns over time, the input dimension of the proposed model is made up of all available sensors. Recurrent neurons arranged in multiple layers are capable of learning complex time-dependent behaviours. In the described embodiment, LSTM neurons are used, though alternative neuron structures such as gated recurrent neurons (GRU) could be used which may in some cases provide advantages in model training efficiency. Once the recurrent encoder reads all the input information, the sequence is summarised in a context vector c which is a fixed-length multidimensional vector representation [symbol] ^{H} (Eqn 8b).

The function of the encoder structure is to map a time-ordered sequence of multi-dimensional vectors (each input vector comprising a set of sensor readings for each of the sensors in the input set, at a particular time instance) into a fixed-length vector representation (Eqn 8c). In this way, the RNN encoder achieves a compression ratio of

$$\frac{( {T}_{i} * P )}{H} .$$

The compression ratio should preferably be high enough in order to provide a choke point, so that the encoder can learn useful knowledge. The model may risk learning a useless identify function if the compression ratio is too low (e.g. if the hidden dimension H is too large). In example embodiments, compression ratios of at least 5 and preferably at least 10 are used. In one concrete example, good results were obtained for values of tᵢ=36 and P=158 (36 time increments and 158 input sensors), with a context vector having H=400 component values, resulting in a compression ration of

$$\frac{( 36 \times 158 )}{400} = 14.22 .$$

As the seq2seq network is trained end-to-end, the context vector is a representation of the input sequence conditioned on the corresponding output sequence. This implies that the context vector can provide useful knowledge in relation to the input-output sequence pair, and such information can be analysed in order to generate meaningful diagnostic measurements as will be discussed later.

Update hidden state of encoder:

hₜ=f(hₜ₋₁,xₜ), t=1, 2, 3, . . . , Tᵢ (Eqn 8a)

Output context vector:

c=f(h_{T}_{ᵢ}) (Eqn 8b)

Encoder function:

f_{encoder}{ [symbol] ₜ^{P}: t∈[1, Tᵢ]}→C (Eqn 8c)

Decoder

The decoder 1040 is a recurrent network which converts the context vector c (1030) into the sequence of output vectors 1034. To exemplify this, the decoder starts by reading the context vector c at t=1 (Eqn 9a). It then decodes the context information through the recurrent multilayer structure and outputs the vector y₁ at the first decoder time step which maps back to Ŷ₁ in the final layer. Afterwards, the decoder's hidden state is passed on to the next time step and the new state is computed based on the previous state hₜ₋₁ as well as the previous vector output yₜ₋₁ (Eqn 9b). The RNN decoder carries on making predictions at each output step until it reaches the total length of the output sequence length Tₒ. In essence, the decoder decompresses the information stored in the context vector into the output multidimensional sequence (Eqn 9c).

Initiate decoder:

h₁=f(c) (Eqn 9a)

Update hidden state of decoder:

hₜ=f(hₜ₋₁, yₜ₋₁), t=2, 3, 4, . . . , Tₒ (Eqn 9b)

Decoder function:

f_{decoder}: c→{ [symbol] ₜ^{K}: t∈[1, T₀]} (Eqn 9c)

Recurrent Autoencoder

Preferred embodiments of the invention implement the above-described seq2seq model in the form of a recurrent autoencoder that maps the input data back into itself through the neural encoder-decoder structure. The encoder structure compresses multidimensional input data into the vector representation of the context vector, while the decoder structure then receives this information and reconstructs the original input data. Thus, in the present examples, the sensor data provided as input 1022 to the seq2seq model (FIG. 10) is regenerated at the output 1034 of the model. Converting the seq2seq model into an autoencoder setting with recurrent properties is achieved by fixing the input sequence length Tᵢ and output sequence length Tₒ to be identical, and thus the input/output length will now simply be denoted as T.

Training of the autoencoder RNN in this case involves an error function (also referred to as the loss function) that quantifies the error in the output vector (set of sensor data) at a given sample time t compared to the corresponding input vector at the same sample time. Any suitable error function as described above (e.g. mean-squared error) can be used. Backpropagation is performed through the entire autoencoder network as described above during training until an appropriate termination or convergence criterion is met. In a preferred embodiment, training proceeds iteratively, with each outer iteration termed an “epoch”. During each epoch, the entire set of training data is processed; i.e. the sensor data for all sensors at each sample time are input to the neural network (iterating over the sample time increments using a sliding window as described in more detail below). Training continues until no improvement in terms of the error function is seen over a given number of epochs, for example until the value of the error function does not change (or changes by less than a threshold amount) over the given number of epochs (e.g. 10 epochs). Other termination criteria could be used alternatively or additionally, e.g. the value of the error function falling below a defined error threshold, or a maximum number if epochs.

After the termination criterion is met, training ceases. The value of the error is then evaluated to determine whether the network has indeed converged—if the value is sufficiently low (e.g. below a defined convergence threshold), then this means that the autoencoder network reproduces the input sensor data 1022 at the outputs 1034 with sufficient accuracy that the context vector can be taken as a reliable summarisation of the sensor data (and therefore a useful diagnostic indicator of the process state). The autoencoder network can therefore now be used to process unseen (e.g. real-time) data.

On the other hand, if training ceases (e.g. after a maximum number of iterations or after the value of the error function has stopped reducing for a number of epochs), but the value of the error function remains high (above the convergence threshold), this may mean that the network has not successfully learnt a mapping that correctly maps the input signals back onto themselves, in which case the context vectors may not provide a useful summary of the sensor data (and hence may not be useful for process diagnostics). In that case, the network may be retrained by varying one or more hyperparameters (neural network configuration, optimisation strategy etc.) as discussed further below, until a satisfactory result is achieved.

While a characteristic of an autoencoder is the ability to map input data back into itself via a context vector representation, in a preferred embodiment, this criterion is relaxed such that output dimension K is smaller than the input dimension P, which means the output { [symbol] ₜ^{K}: t∈[1, T]} is a (proper) subset of the input { [symbol] ₜ^{P}: t∈[1, T]} (Eqn 10). As a result, the encoder receives a high dimensional input (corresponding to the complete set of sensors under consideration) but the corresponding decoder is only required to decompress a subset of the original dimensions in the output sequence (corresponding to a subset of the original sensors for which sensor data was provided as input). End-to-end training of this reduced dimensionality seq2seq autoencoder means that the context vector summarises the input sequence (all sensors) while still being conditioned on the output sequence (selected subset of sensors).

Seq2seq autoencoder with output dimensionality relaxation:

$$\{ \begin{matrix}{f}_{encoder} \text{:} \{ {t}_{P}^{} \text{:} t ∈ [ 1 , T ] \} \to c \\ {f}_{decoder} \text{:} c \to \{ {t}_{K}^{} \text{:} t ∈ [ 1 , T ] \}\end{matrix} K \leq P \qquad ( Eqn 10 )$$

Note that (Eqn 10) represents the generalised form of the autoencoder, permitting but not requiring reduced output dimensionality. In a preferred embodiment, the number of output signals is less than the number of input signals, i.e. K<P. In other words, the output sensor set is a strict (or proper) subset of the input sensor set.

Having a (strict) subset of dimensions in the output sequence has significance for practical applications of the algorithm. In the industrial process use case, all streams of sensor readings are included in the input dimension while only part of the selected sensors would be included in the output dimensions. This means the entire process state is visible to the encoder RNN, thus enabling it to learn complex patterns efficiently.

Furthermore, the context vector is conditional on the selected sensors as defined in the output dimensions. It only activates if the decoder captures patterns in the set of selected sensors in the output sequence. Similar sensor patterns across different samples would result in very similar activation in the hidden context vector as they are located in close vicinity of each other. Contrarily, abnormal sensor patterns would lead to activation in relatively distant space which effectively provides means to distinguish irregular patterns and usual behaviour.

As an example, while the input sensor set could include a variety of sensors, such as temperature, pressure, vibration etc., only a specific type and/or subset of sensors may be selected for the decoder output—for example, a set of key pressure sensors (since in the compression train example, those may be considered of greatest interest or significance). In this way, the autoencoder can be trained to summarise the input data in a way that focuses on pressure-relevant features, such that the pressure data is accurately recovered at the output.

In preferred embodiments, the ratio of output sensors to input sensors is no more than 0.5. However, training can be focussed more effectively at lower ratios, and thus a ratio of no more than 0.2 or more preferably no more than 0.1 is preferred. This approach has been found particularly effective with a ratio of no more than 0.05; for example, in the specific application example described elsewhere, a ratio of 6 output sensors to 158 input sensors was used (ratio=0.038).

Given that the context vector is a compressed and timeless summary of complex patterns in the input-output sequences pair, it can be used as a diagnostic measurement for the process state while being conditioned on the key sensors.

Following this approach, several seq2seq autoencoder models can be trained using different output dimensions in order to capture different patterns across different sensor sets.

Temporal Sampling for the Encoder Input

Note that the input sequence 1022 to the autoencoder comprises a sensor data vector (comprising sensor data values for each of the P input sensors) for each time instance t=1 . . . T. Each time instance corresponds to a sample/measurement time of the associated sensors (possibly after pre-processing to down-sample and/or produce data at a consistent time resolution as described previously). Thus, each time instance can be considered to correspond to a distinct input channel of the encoder (and analogously, a corresponding output channel of the decoder), with each input/output channel representing a given time instance within the time window covered by the autoencoder.

As the length of input and output sequences are fixed as T in the described seq2seq autoencoder model, the time series input drawn from the source sensor data should have the same length too. To generate training samples from a subset of length T′ where T′>T, the system begins at t=1 and draws a sample of length T. This process continues iteratively by shifting one time step until it reaches the end of the subset sequence. This can allow for online (real-time) training and prediction to support time-critical applications like sensor data processing. For a subset sequence of length T, this method allows T′−T samples to be generated.

The consecutive sampling algorithm is illustrated below.

Algorithm: Consecutive Sampling

Input: Sample sequence length T
Input: Subset sequence length T′
1 i ← 0 ;
2 while i ≤ i + T do
3 Generate sample sequence (i, i + T] from the subset sequence;
4 i ← i + 1;
5 end

Operation of the algorithm is illustrated schematically in FIG. 11.

During real-time monitoring, a similar sliding window approach is used, with input samples provided to the trained network for each of the Tᵢ time instances (input channels). At each time increment, the input vectors are shifted by one time channel to produce the next autoencoder input (with the oldest vector being dropped and the input channel corresponding to the most recent time instance supplied with an input vector corresponding to the most recent real-time sensor data).

Autoencoder Output and Clustering

The above approach to generating input samples also affects the encoder output. Given that input sample sequences are iteratively generated by shifting one time step, successive sequences are highly correlated with each other. This means that when they are fed through the encoder structure, the context activation c would also be highly correlated. As a result, consecutive context vectors can join up to form a smooth path in high dimensional space. The context vectors can be visualised in lower dimensions via dimensionality reduction techniques such as principal component analysis (PCA).

As discussed previously, the fixed-length context vector representations summarise information in the input sequence. Context vectors in the same neighbourhood have similar activation therefore can be considered as belonging to a similar underlying state (of the set of input sensor data). Contrarily, context vectors located in different neighbourhoods have different underlying states. In light of this, clustering techniques can be applied to the context vectors in the training set in order to group similar sequences together.

Thus, after initial training of the autoencoder on the training set until the autoencoder satisfactorily reproduces the input sensor data at its outputs (during which the generated context vectors are discarded), the trained autoencoder is applied again to the training samples (alternatively a new set of training samples could be used) and the generated context vectors are extracted.

Each context vector is then assigned to a cluster Cⱼ where J is the total number of clusters (Eqn 11).

Assigning cluster to context vector:

c→Cⱼ, j∈{1, 2, 3, . . . , J} (Eqn 11)

Once all the context vectors are labelled with their corresponding clusters, supervised classification algorithms can be used to learn the relationship between them using the training set. For instance, a support vector machine (SVM) classifier with J classes can be used. The trained classifier can then be applied to the context vectors in the held-out validation set in order to assign clusters.

The process state can be considered changed when successive context vectors move from one neighbourhood to another (e.g. the context vector substantially drifting away from the current neighbourhood leading to a different cluster assignment).

Evaluation

In evaluating the proposed algorithms, various seq2seq autoencoder models in accordance with embodiments of the invention were trained with different hyperparameters, specifically in relation to batch size, learning rate, optimisers, topology, dropout, output dimensions, order reversal and sequence length. The choice of hyperparameters has implications on the properties of the model as will be discussed in the following section. Any of the algorithm variations (e.g. alternative hyperparameters) discussed in this section may be used in embodiments of the invention. While the results reported here may provide guidance in evaluating and selecting hyperparameters and configuration of the algorithm, the results may to some extent be specific to the FIG. 1 application domain and to the dataset used. In practice, the specific configuration used may depend on application context.

In one example application, a raw sensor dataset from the compression train illustrated in FIG. 1 was recorded at highly granular level but at irregular interval. It was then transformed into regularly-spaced time series using the described tumbling window approach with standard window size W=600 seconds (5 minutes). Elements within each window were aggregated by taking the simple arithmetic average of all members. Training samples were drawn from the sample consecutively with sequence length T=36 (3 hours). The model has input dimensions P=158 and output dimensions K=6 where the selected set of sensors in the output are chosen to represent key performance indicators of the two-stage compression train.

The dataset was divided into two parts, where the first 70 percent of the data belongs to the training set and the remaining belongs to the validation set. In total, there were 2543 sequences in the whole dataset.

In embodiments, both the training and validation sets are standardised into z-scores. The mean of each dimension x̅ₚ is subtracted and the difference from the mean is divided by the standard deviation of the dimension σₚ (Eqn 12). This ensures that all dimensions contain zero-centred values which facilitates gradient-based training.

Standardising dataset using z-score:

$${z}_{p} = \frac{{x}_{p} - {\overline{x}}_{p}}{{σ}_{p}} \qquad ( Eqn 12 )$$

In this example, the models were trained at 32-bit precision on a single Nvidia Quadro P5000 device.

Experiments were conducted on various hyperparameters and they were found to have different effects on the model's properties. All models were trained for 5000 epochs and the gradient was clipped at 0.3 to avoid the exploding gradient problem.

Batch Size

The effects of different batch sizes were assessed using a minibatch gradient descent optimiser. This uses one batch of training samples to perform gradient evaluation. This means when the batch size B is closer to sample's total size N its behaviour would resemble classic batch gradient descent. Alternatively, when B gets smaller or even closer to 1 then it would behave like a stochastic gradient descent (SGD) optimiser.

Several sets of autoencoder models were trained using minibatch gradient descent optimiser with different batch sizes. The models used here (and in the experiments described in the following sections) contained 1+1 layers, 2+2 layers and 3+3 layers in the encoder-decoder structures respectively. All hidden layers contained 400 neurons.

Varying batch size B was found to have subtle effects on the optimiser's properties, with the loss function converging more quickly when B is small. This is because more gradient updates can be packed in a single epoch. In theory, the variance of gradient update also becomes higher when the batch size is small. Volatile gradient update encourages the parameters to improve by jumping towards different directions. Contrarily, large batch size leads to consistent gradient update and thus discourages parameter jumping. The effect is only very marginal in the 1+1 layer scenario, where the validation MSE for smaller batch size is slightly lower that the others. As the number of hidden layers increases, minibatch gradient descent becomes less efficient regardless of the batch size. The training and validation losses of 3+3 layers models remain fairly stagnant compared with shallower models. Only smaller B values were able to bring marginal improvements in deep models.

Learning Rate

The learning rate μ is an important hyperparameter of the optimiser which determines the size of gradient update. On one side, a small learning rate allows tiny steps to be made which encourages better convergence at minima. On the other side, a large learning rate allows rapid learning but it is vulnerable to divergence.

Three sets of models containing different number of hidden layers were trained (all with 400 neurons in each hidden layer), as described above. It was found that the 1+1 layer model was able to converge earlier at a higher learning rate. However, the model becomes prone to overshooting with a high learning rate (e.g. at μ=0.08). Both the training and validation losses experienced a significant increase which indicates divergence. This phenomenon becomes more evident when the model has deeper structure. The models with 2+2 and 3+3 layers structures showed significant divergence at much earlier epochs with even smaller learning rates. This highlights the challenges faced when training deep and complexed RNN structures. More advanced optimisers may ameliorate this.

Advanced Optimisers

Various optional improvements were added to the minibatch gradient descent optimiser and tested alongside other advanced optimisers. As described above, three sets of comparable models were run with different optimisers (using default recommended hyperparameters). All models were trained with same batch size B=256. The optimisers tested were Minibatch with momentum, Minibatch with decay, Minibatch with Nesterov momentum, Adagrad, RMSprop and Adam.

In these experiments, different optimisers showed contrasting results. Minibatch gradient descent optimisers (momentum, decay and Nesterov momentum) managed to improve the training and validation losses of shallower 1+1 layer models. However, the training speed decreased when the model grows deeper with much of the earlier epochs staying stagnant.

Contrastingly, optimisers with adaptive learning rates such as Adagrad, RMSprop and Adam were able to deliver improvements at much earlier epochs for both shallow and deep models. This suggests that adapting the learning rate to each model parameter helps training models with large parameter space. Yet, Adagrad suffers from slow learning in later epochs as both training and validation MSEs flat out. This is caused by diminished learning rate as it is divided by a cumulative term which grows as training epoch proceeds.

Nevertheless, RMSprop showed lower losses across all models but suffers from divergence at later epochs. This suggests that the adaptive learning rates were still too high as the parameters were approaching minima positions, which eventually led to overshooting. This can be resolved by reducing the p value which allows the learning rate to adapt to more recent gradients.

Among all optimisers tested, Adam demonstrated outstanding effectiveness at training both shallow and deep models without causing divergence or slow learning. The training MSEs of Adam decrease continuously as epochs increase. The corresponding validation MSEs show gradual decrease simultaneously, followed by moderate increase without showing signs of parameter divergence. This shows that even with its default configuration, Adam is a suitable optimiser for a wide range of models.

Topology

The processing power of the network is primarily determined by the topology. Thus, in further experiments, several models were trained with same hyperparameters except the number of neurons and the number of hidden layers were changed. All models were trained with the Adam optimiser.

It was found that there were commonalities across different topological configurations. Firstly, the training losses of all models were found to improve along successive plateaus and cliffs. This may a problem of high dimensional data where the loss space is likely to be non-convex. In other words, the loss space is dominated by saddle points where minima exist in some dimensions but not in the others. The parameters experience lower gradients near the saddle point hence the loss function appears like a plateau. Once the optimiser learns a way to escape the saddle point, the training loss improves rapidly again.

Apart from this, the validation losses of all models were found to share a common V-shape, indicating that the knowledge learned by the models is generalizable to unseen data as the validation losses reach the minimum point. Gradual increase of the validation MSEs in later epochs was found, suggesting model overfitting. This means that the model is still learning on the training data but the knowledge acquired becomes less generalizable to the unseen validation data.

On the other side, changing the number of neurons while controlling the layer depth was found to effect the MSE loss. Adding neurons provides additional non-linear computation as well as memory capacity to the models. The effect was consistent across all models as both training and validation MSEs decreases when more neurons were supplied.

Furthermore, altering the number of hidden layers while keeping the same number of neurons at each layer was found to have various effects on the MSE loss too. For the training loss, shallow models showed improvements much faster than deep models. An intuitive explanation for this phenomenon can be attributed to the shortened distance between input and output when the number of hidden layers is reduced. Although in theory deep models tend to outperform shallow models, they are harder to train in reality. Error amplifies through deep structure which can lead to inferior results, suggesting that regularisation may in many cases be beneficial in order to train deep networks successfully.

Dropout

Regularisation can be important when it comes to training deep and complex model structures. Different dropout rates were tested on several models. High dropout rate was found to mask a large part of the network which results in generally slower training. Despite this, it helps with suppressing the variance of model losses. The variance of training MSEs across all models were found to be lower with high dropout. Moreover, the models without dropout in both 2+2 and 3+3 layers scenarios showed rapid training but eventually suffered from parameter divergence. High dropout was able to prevent this situation.

Output Dimensions

For an autoencoder model, the input and output dimensions are usually identical (i.e. K=P). However as we discussed earlier, in preferred embodiments, the dimension of the output sequence is relaxed such that K≤P.

In the autoencoder model, the input sequence's dimensionality was defined by the complete set of available sensors (P=158). The relaxed output dimensionality was set at K=6 which includes a set of sensors chosen to reflect key measurements of a specific aspect of the system process (e.g. pressure). Experiments were conducted for three scenarios where the first two have complete dimensionality P=158; K=158 and P=6; K=6 while the remaining scenario has relaxed dimensionality P=158; K=6. Once again, three sets of models were trained, each with different numbers of hidden layers in the encoder-decoder structure (all with 400 neurons in each hidden layer). Models were trained with the Adam optimiser at B=256 with no dropout.

The first model with complete dimensionality (P=158; K=158) has visibility of all sensors in both the encoder and decoder. The model showed relatively slow improvement as they contain high dimensional data in both input and output sequences. This could be due to the lack of capacity in the RNN encoder-decoder structure to accommodate sequences at such high dimensionality.

For the complete dimensionality model with P=6; K=6, the model has visibility to the selected dimensions only. The remaining dimensions (i.e. remaining sensors of the system) were kept away from the encoder and decoder. This means that the autoencoder model is prohibited from learning any dependent behaviours among all the original dimensions. Besides, the model's capacity is too large for handling P=6; K=6 and this leads to poor compression at the context layer. This led to poor generalisation as indicated by high validation losses encountered for deeper models. Seq2seq autoencoder models with relaxed dimensionality were found to demonstrate substantially lower training and validation MSEs across all scenarios. The third model has relaxed dimensionality with P=158; K=6, meaning that all dimensions are available in the encoder while the decoder only needs to predict a subset of the input dimensions. It was found that this permits the autoencoder model to learn dependency across all dimensions, leading to better and more consistent MSEs.

Order Reversal

Several models were trained with exactly the same hyperparameters with the exception that the input sequence was reversed while the output sequence remained chronologically ordered. Again three sets of models were trained, each with different numbers of hidden layer in the encoder-decoder structure but with 400 neurons in each hidden layer. Models were trained with Adam optimiser at B=256 with no dropout. However, reversing the input sequence was found in this case to have a detrimental effect on the model's validation loss, with the reverse models performing worse in all scenarios, producing larger validation MSEs.

When the sequence is reversed, the end of the input sequence is highly correlated with the output sequence's beginning. This encourages the LSTM to overwrite previously learned information in the hidden recurrent state, which eventually sacrificing longer-term memory and worsened the model's loss.

It is also possible to combine both forward and reverse orders at the same time by using bidirectional RNN (BRNN). Use of a BRNN-based encoder may be expected to outperform either forward or reverse RNN.

Sequence Length

For any given model with fixed number of layers and neurons, the sequence length T can be varied in order to show the effects of the seq2seq autoencoder. Again three sets of models with different layer numbers were trained with Adam optimiser at B =256 with no dropout.

A pattern was found where models with shorter sequence length T have the smallest training and validation loss. The MSE was found to go up when the sequence length T was increased.

In theory, shorter sequences can be more effectively encoded into context representation as they contain less information; whilst, longer sequences naturally contain more information. The context vector may become bottleneck when handling long sequences. This suggests that the RNN encoder-decoder structure requires more memory capacity in order to handle longer sequences successfully.

Analysing Context Vectors

Once the seq2seq autoencoder model is successfully trained, the fixed-length context vectors can be extracted from the model and examined in greater detail. Following the example in previous section, the same model was used to extract context vectors.

As was discussed earlier, successive context vectors have similar activation as they are only shifted by one time step. A correlation matrix of all context vectors was calculated and visualised on a heat map, revealing that nearby context vectors are indeed highly correlated.

In the selected model, the context vector c is a 400-dimensional vector R⁴⁰⁰. Dimensionality reduction of the context vectors through principal component analysis (PCA) revealed that context vectors can be efficiently embedded in lower dimensions (e.g. two-dimensional space). At the lower-dimensional space, supervised classification algorithms are then used to learn the relationship between vector representations and cluster assignment. The trained classification model is then applied to the validation set to predict cluster memberships of any unseen data.

In one experiment, a SVM classifier with radial basis function (RBF) kernel (γ=4) was used. Both training and validation sets were fed to the model and the context vectors were extracted. The context vectors were projected into two-dimensional space using PCA. The resulting clusters are shown in FIGS. 12A-12D (showing clustering for 2, 4, 6, and 7 clusters respectively). The black solid line joins all consecutive context vectors together as a travelling path. Different numbers of clusters were identified using a K-means algorithm.

In order to understand the meaning of the context vectors, the output dimensions can be visualised on a time axis. FIG. 13 shows an example, for the two-cluster model of FIG. 12A. The black vertical line demarcates the training set (70%) and validation set (30%). The successive line segments match the clusters in the previous FIG. 12A.

The context vectors are able to extract meaningful features from the sequence. As seen in FIGS. 12A-12D, in the two-dimensional space, the context vectors separate into two clearly identifiable neighbourhoods which correspond to the shift in mean values across all dimensions. When a K-means clustering algorithm is applied, it captures these two neighbourhoods as two clusters 1202, 1204 (outer cluster) in the first scenario (FIG. 12A). When the number of clusters increases, they begin to capture more subtle variations. For instance, the context vectors in the upper right quadrant in the 4 clusters scenario (FIG. 12B) correspond to extreme values across different dimensions. At the same time, the outer cluster 1206 reflects deep troughs in the fifth dimension. This indicates the recurrent autoencoder model is capable of encoding temporal patterns into a fixed-length vector representation.

When the number of clusters is further increased, even more details are captured. In the 6 clusters scenario (FIG. 12C), successive context vectors travel back and forth between cluster 1208 and cluster 1210. This is also apparently driven by the oscillation of the fifth dimension. When the mean level begins to shift, the context travels between clusters 1212 and 1214 instead. Such a pattern can also be observed in the validation set, which indicates that the knowledge learned by the autoencoder model is generalizable. When the number of clusters is increased to 7 (FIG. 12D), consistent behaviour can still be observed.

Furthermore, the clusters can be closely examined by extracting the mean values of each dimension along the sequence and grouped by clusters. FIG. 14 illustrates all the dimensions of the 6 clusters scenario (the horizontal axis is the time step where T=36). Again, it shows that clusters are able to capture different temporal patterns. For instance, we already know that the context vectors drift between clusters 1208/1210 and clusters 1212/1214. The dimensional mean values of these cluster pairs have substantially different shapes.

The seq2seq autoencoder model was also applied to a different set of selected sensors, containing only two sensors in the decoder output (P=158; K=2) and thus measuring a specific aspect of the system process. The context vectors were again extracted for further examination and analysed as described above. Once again, successive context vectors were found to form a smooth travelling path. The context vectors drift within a neighbourhood when the sequences have similar activation and travel away from the original neighbourhood when activations become sufficiently different.

Optimiser

Preferred embodiments of the invention employ the Adam optimiser, since (as discussed above) this was found during evaluation to produce good results. The Adam optimiser was proposed in Diederik P. Kingma and Jimmy Ba, “Adam: A method for stochastic optimization”, International Conference on Learning Representations (ICLR), San Diego, 2015.

The Adam optimiser combines the concept of adaptive learning rate and momentum. It has parameters mₜ and vₜ which stores the decaying past gradient (Eqn 13a) and the decaying past squared gradient (Eqn 13b) respectively. These two terms are responsible for estimating the gradient's mean and variance. As these parameters are initialised as zeros at the initial step, they are strongly inclined towards zero in most of the early weight update stages. In light of this, the bias adjusted values \hat{m}ₜ and \hat{v}ₜ are computed by dividing the unadjusted value over a logarithmically saturating term (Eqn 13c) (Eqn 13d). The bias adjusted values are then used to compute the gradient update (Eqn 13e).

Decaying past gradient:

mₜ=β₁mₜ₋₁+(1−β₁)∇L_{w(t,i)} (Eqn 13a)

Decaying past squared gradient:

vₜ=β₂vₜ₋₁+(1−β₂)(∇ [symbol] _{(t,i)})² (Eqn 13b)

Bias adjustment:

$$\begin{matrix}{\hat{m}}_{t} = \frac{{m}_{t}}{1 - {β}_{1}^{t}} & ( Eqn 13 c ) \\ {\hat{v}}_{t} = \frac{vt}{( 1 - {β}_{2}^{t} )} & ( Eqn 13 d )\end{matrix}$$

Gradient update:

$${w}^{′} = w - \frac{μ}{\sqrt{{\hat{v}}_{t}} + ϵ} {\hat{m}}_{t} \qquad ( Eqn 13 e )$$

Discussion

The present disclosure describes how a seq2seq model can be adapted into a recurrent autoencoder setting. Embodiments of the invention propose dimensionality relaxation of the autoencoder, which allows the autoencoder model to produce partial reconstruction of the input sequence. This makes more information available and allows the context layer to summarise the input sequence conditionally based on the corresponding output.

In the described approach, multiple streams of sensor values are fed to the autoencoder model by treating them as a multidimensional sequence. The encoder structure compresses the entire input sequence into a fixed-length context vector which is conditional on the decoder's output. The context vectors can then be extracted and analysed to determine information about the state of the industrial process or machine being monitored, for example by performing cluster-based classification of context vectors.

In the described embodiments, input sequences are generated iteratively by shifting the input by one time step. Successive context vectors generated in this way are highly correlated, thus forming a travelling path in high dimensional space.

Dimensionality reduction techniques and clustering algorithms can be applied to aid visualisation. These properties allow the described approach to be used to create diagnostic measurements for large-scale industrial process.

When the sensor data is fed to the seq2seq model as multidimensional sequences, the data gets compressed into a context vector which drifts within a neighbourhood. A decision boundary can be imposed (e.g. one-class SVM) to define the neighbourhood boundary of the normal healthy state. As described above, the seq2seq autoencoder model can also be applied in an on-line setting which allows diagnostic measurements to be generated with real-time data. For instance, an alert can be triggered when the context vector travels beyond the known healthy neighbourhood. This idea is illustrated FIG. 15A (showing a process with a single healthy state). FIG. 15A depicts a cluster 1502 defined by a decision boundary 1504. When the path 1506 of the context vector leaves the neighbourhood of the cluster by passing the decision boundary, this can be taken as an indication that the process or machine has entered an abnormal state, and actions can be taken automatically to deal with this, for example, generating and transmitting an operator alert (e.g. for display on an operator console, for transmission via electronic communication e.g. emailinstant message, or the like).

As a concrete example, this approach of detecting deviation from one single healthy operational state may be applied in the context of the FIG. 1 compression train as follows. Typically, the compression system elevates gas pressure to a certain level and discharges the pressurised gas to other downstream systems. The output pressure is therefore highly regulated at a pre-set level. The sensor data (including pressure) can be fed to the model and the corresponding context vectors can be extracted. A large cluster would correspond to the normal operational state and all other peripheral smaller clusters would correspond to abnormal states (e.g. loss of pressure, or change in discharge cycle). Alarms can be triggered so that process operators can investigate, or alternatively it can be logged for maintenance/diagnostic purposes. The action may depend on the context vector; e.g. a small deviation from the healthy cluster may merely be logged for review/maintenance, while a large deviation (large travel distance) may trigger an alert for immediate attention.

For more dynamic processes, sensor measurement may fluctuate at multiple ranges with transition between multiple states. The movement of context vectors can be used to create meaningful diagnostic measurements, such as when the system changes from one state to another. This is illustrated in FIG. 15B (showing a multi-state process with transition between states). Here, two stable states exist corresponding to two clusters 1510, 1512, delineated by decision boundary 1514. Travel of the context vector across the decision boundary represents a transition between the two operating states of the monitored system.

As a concrete example, compressor systems such as depicted in FIG. 1 require consistent lubrication. If the lubrication system deteriorates (as the lead variable), compression efficiency would deteriorate accordingly (as the lagged effect) and this should be reflected as abnormal patterns through pressure measurement sensors. The context vectors produced would form two distinct clusters in this case corresponding to healthy operation (good lubrication) and unhealthy operation (low/poor lubrication). Process operators can use the cluster output and SVM classifier generated in the training phase to manually label healthy/unhealthy states for each cluster. Alarms can be triggered in real-time during online process monitoring when the context vector drifts beyond the boundary of the user-defined ‘healthy’ cluster (i.e. detecting the change of state). Process operators can then investigate further and take the necessary action (e.g. to optimise the lubrication system) and thus reduce the potential for outage.

As a further example, vibrations are expected at compression systems but for safety the machine would typically trip when vibration exceeds a certain threshold. The described algorithms can be used to detect different kinds of vibrational patterns, including those at high vibrational level (or just before it reaches high level). Context vectors can be used to create clusters for manual labelling of vibration patterns, then alarms can be triggered when the context vector drifts beyond the pre-defined cluster boundary. Operators can then adjust process settings to reduce vibration (and hence prevent vibration tripping and causing shutdown of the system).

While described in relation to a specific industrial process, the described seq2seq autoencoder model can be applied to any multi-sensor multi-state processes. For example, it can be extended to vehicle telematics or Human Activity Recognition in an on-line setting using pre-trained models. In any such applications, alerts can be triggered when the context vector drifts away from a known neighbourhood, or when it travel between two known neighbourhoods (i.e. a state transition).

As a further example, the system could be used to monitor the correct operation of a heating, ventilation and/or air conditioning (HVAC) system. For example, in a domestic setting, input sensors may include one or more temperature sensors in a domestic building, flow measurements for fuel or water, pipe temperature sensors (e.g. detecting pipe freezing), boiler on/off indications, control schedule set points, and/or boiler diagnostic outputs. Autoencoder and classification models may be trained using the described techniques to represent known operating states (possibly including known failure states) of boilers or other HVAC systems. Real-time monitoring based on the trained models may then be used to detect operating conditions such as low fuel efficiency, degradation, impending failure, or actual failure of the system.

The described embodiments use the seq2seq model as an autoencoder, with the context vectors used as diagnostic indicators in relation to the state of the monitored process or machine. However, in principle the seq2seq model can also be used to make predictions of future sensor states (e.g. one or multiple time steps ahead). This involves feeding a multidimensional sequence at t={1, 2, 3, . . . , T} to the encoder and causing the decoder to output the sequence at t={T+1, T+2, T+3, . . . , T+h} where h is the number of time steps ahead we want to forecast. It has been found that this approach can be effective for sensors with strong seasonality, with the RNN encoder-decoder structure able to capture repeating patterns at multiple steps ahead.

Computer System

FIG. 16 illustrates in overview an exemplary computer system for implementing described embodiments. The system comprises the industrial process or machine 1602 being monitored, which may e.g. be or include the compression train 100 depicted in FIG. 1A, and includes a set of sensor devices 1604 of various types and at various locations of the process/machine. The sensors produce streams of sensor data collected by a sensor data collection system 1606 (e.g. this may be in the form of a general-purpose computer device running data collection software, dedicated hardware, or a combination). The collected sensor data is recorded in a sensor data database 1608.

Offline learning system 1610 processes historical sensor data from the database 1608 in the manner described above (including any necessary pre-processing), to train one or more seq2seq autoencoders. The trained autoencoder models are stored in a model database 1612, e.g. as the relevant neural network configurations including the learnt set of weights. In a simple case, a single model may be trained, but alternatively, multiple models may be trained, for example focussing on different aspects of the process or machine. For example, one model could focus on pressure behaviour (e.g. selecting relevant pressure sensors for the reduced set of K output dimensions), whilst another could focus on temperature behaviour (selecting relevant temperature sensors for the decoder output). As a further example, different models could focus on different parts or subsystems of the process/machine; for example, one model could focus on sensors associated with the LP stage 102 of the FIG. 1A system, whilst another model could focus on sensors associated with HP stage 104.

Different models could differ in the selection of input sensors (input dimensions [symbol] ^{P} in FIG. 10), the selection of output sensors (output dimensions [symbol] ^{K in} FIG. 10), or both. Alternatively/additionally, different models could vary in the algorithm hyperparameters, e.g. models could be trained with different numbers of hidden layers, different number of neurons per layer, different context vector size, etc., in any appropriate combination. Thus, different models could be tuned to improve detection of specific operating states and conditions.

A real-time monitoring system 1614 applies real-time sensor data inputs from the sensor data collection system to the trained models from model database 1612 (note that at any time all or only a subset of the models may be in use for real-time monitoring; e.g. operators may activate/deactivate particular models based on monitoring needs). Applying real-time sensor data to a model results in generation of a series of context vectors and their associated classification in relation to the vector clustering established during the training phase. Based on the analysis (e.g. classification of a context vector or series of context vectors as being part of a particular cluster, or as deviating from a particular cluster), user alerts may be generated for transmission to an operator workstation or other device 1616. For example, certain alerts could be transmitted to a mobile telephone device of an operator in the form of a Short Message Service (SMS) message or other electronic / instant message, or could be displayed via a monitoring interface on a workstation. In some cases, control commands could also be transmitted directly to the process/machine via a control system 1618, for example to change operating parameters (e.g. to compensate for a detected operating state, e.g. raise pressure if sensor readings suggest pressure is falling below tolerances) or to initiate a safe shutdown of the process/machine.

The various components are shown as interconnected by a computer network 1620. This may in practice include any combination of wired and wireless networks, including public networks (such as the Internet), private local area networks (LANs) and the like.

While various components are shown for illustrative purposes as being separate, such components may be combined; for example, the offline learning system 1610, real-time monitoring system 1614 and model database 1612 could be implemented by a single server computer. Furthermore, the functionality of individual components may be divided across multiple components (e.g. offline learning system 10 and/or real-time monitoring system 1614 could be implemented on a cluster of computers for processing efficiency). Alerts and other messages indicating detected operating states of system 1602 could be output to multiple workstations and/or other devices associated with multiple operators.

FIG. 17 illustrates the hardware and software components of a computing device in the form of server 1700 suitable for carrying out described processes.

The server 1700 includes one or more processors 1702 together with volatile/random access memory 1704 for storing temporary data and software code being executed. A network interface 1708 is provided for communication with other system components over one or more networks 1620 (e.g. Local or Wide Area Networks, including the Internet).

Persistent storage 1706 (e.g. in the form of hard disk storage, optical storage and the like) persistently stores analysis software for performing the described sensor data analysis functions, including an offline learning module 1710 which trains one or more seq2seq autoencoders and associated classifiers based on historical sensor data 204, and real-time monitoring module 1712 which receives real-time sensor data 206, applies it to one or more trained autoencoders and associated classifiers and detects operating states of the monitored process, machine or system. The persistent storage also includes other server software and data (not shown), such as a server operating system.

The server will include other conventional hardware and software components as known to those skilled in the art, and the components are interconnected by a data bus (this may in practice consist of several distinct buses such as a memory bus and I/O bus).

While a specific architecture is shown by way of example, any appropriate hardware/software architecture may be employed.

Furthermore, functional components indicated as separate may be combined and vice versa. For example, the functions of server 1700 may in practice be implemented by multiple separate server devices (e.g. by a computing cluster).

It will be understood that the present invention has been described above purely by way of example, and modification of detail can be made within the scope of the invention.

1. A method of detecting an operating state of a process, system or machine based on sensor signals from a plurality of sensors, the method comprising:
receiving sensor data, the sensor data based on sensor signals from the plurality of sensors;
providing the sensor data as input to a neural network, the neural network comprising:
an encoder sub-network arranged to receive the sensor data as input and to generate a context vector based on the sensor data, wherein the encoder sub-network is adapted to encode sensor data patterns from the plurality of sensors over a predetermined time window; and
a decoder sub-network arranged to receive the context vector as input and to regenerate sensor data corresponding to at least a subset of the sensors based on the context vector;
comparing the context vector to at least one context vector classification;
detecting an operating state in dependence on the comparison; and
outputting a notification indicating the detected operating state.

2. The method according to claim 1, wherein:
the operating state comprises a fault condition, and
the method optionally comprises identifying the fault condition based on one of:
a divergence of the context vector from at least one classification associated with a normal operating state; and
membership of the context vector in a predetermined classification associated with the fault condition.

3. (canceled)

4. The method according to claim 2, further comprising generating an alert in response to identifying the fault condition, and transmitting the alert to an operator device.

5. The method according to claim 1,
wherein the decoder sub-network is arranged to regenerate sensor data for a selected proper subset of the plurality of sensors;
optionally wherein the encoder sub-network comprises respective inputs for each of the plurality of sensors; and
wherein the decoder sub-network comprises respective outputs for the proper subset of the plurality of sensors.

6-7. (canceled)

8. The method according to claim 1, wherein the plurality of sensors comprises at least one of:
sensors associated with measurement of a plurality of distinct physical properties, and wherein a selected subset of sensors are associated with a subset of the plurality of distinct physical properties or with a single one of the distinct physical properties; and
sensors associated with distinct parts or subsystems of the process, system or machine, and wherein the selected subset of sensors are associated with a subset of, or a single one of, the plurality of distinct parts or subsystems.

9. (canceled)

10. The method according to claim 1, further comprising:
changing the sensor data supplied to the neural network at each of a plurality of time increments; and
obtaining from the neural network a respective context vector for each of the time increments,
wherein the time window is optionally defined by a plurality of measurement intervals or increments, a plurality of equally spaced time increments.

11. (canceled)

12. The method according to claim 1, wherein:
the encoder sub-network comprises respective sets of inputs for the plurality of sensors for each of a plurality of time increments; and
the method optionally comprises supplying respective input vectors to each set of inputs, each respective input vector associated with a respective sample time and comprising sensor data values for the plurality of sensors corresponding to the respective sample time.

13. (canceled)

14. The method according to claim 12,
wherein each respective set of inputs defines an input channel associated with a respective time increment;
wherein the context vector optionally comprises a predetermined number of data values; and
wherein the predetermined number is less than the number of input channels multiplied by the number of sensor inputs in each channel.

15. (canceled)

16. The method according to claim 14,
further comprising, at each time increment, shifting sensor data samples input to the neural network by a predetermined number of input channels, wherein the predetermined number is optionally one;
wherein the encoder subnetwork optionally comprises a fixed number of input channels;
and wherein shifting sensor data samples comprises:
dropping samples of a channel corresponding to a least recent time increment,
shifting sensor data samples from the remaining input channels by one input channel, and
supplying new sensor data samples to an input channel corresponding to a most recent time increment.

17. (canceled)

18. The method according to claim 14,
wherein the decoder subnetwork comprises a predetermined number of output channels each associated with a respective time increment and comprising outputs for respective regenerated sensor signals,
and optionally wherein the number of input channels of the encoder subnetwork is equal to the number of output channels of the decoder subnetwork.

19. The method according to claim 1,
the method further comprising training the neural network using a training set of sensor data from the plurality of sensors, wherein training the neural network comprises using an error function quantifying an error in the regenerated sensor data to adjust weights in one or both of the encoder sub-network and the decoder sub-network; and
the method optionally further comprising training the neural network until a termination criterion is met, the termination criterion comprising one of: the change in the value of the error function remaining below a threshold, and no change in the value of the error function occurring, over a predetermined number of iterations, wherein each iteration comprises training the neural network using the training data set.

20. (canceled)

21. The method according to claim 19,
the method further comprising training the neural network on a sequence of training samples, each training sample comprising a set of input vectors corresponding to a plurality of respective time increments, and
the method further comprising selecting a given training sample from a temporally ordered training set of input vectors by shifting a selection window by one or more predetermined time increments.

22. The method according to claim 19, further comprising, after training the neural network:
applying the neural network to a training set of sensor data, the training set optionally the same as or a different from the training data set used to train the neural network, to generate a plurality of context vectors; and
determining the at least one context vector classification based on the context vectors, wherein determining at least one context vector classification optionally comprises performing a clustering on the context vectors to identify one or more clusters of the context vectors, and optionally assigning a classification to each identified cluster, wherein assigning a classification to each identified cluster optionally comprises training a classifier based on the identified clusters.

23-24. (canceled)

25. The method according to claim 22, wherein the at least one context vector classification comprises one or more context vector clusters, and
wherein detecting an operating condition comprises determining at least one of:
a membership of the context vector in one of the identified clusters;
one or more distances of the context vector from one or more respective ones of the identified clusters;
wherein identifying an operating condition optionally comprises detecting an abnormal operating condition based on the context vector not matching one of the identified classifications or clusters and/or based on a distance of the context vector to a nearest identified cluster exceeding a threshold distance.

26. (canceled)

27. The method according to claim 1,
the method further comprising pre-processing the sensor signal data to generate sets of sensor data for each sensor having the same temporal resolution,
the method optionally comprising summarizing sensor data for one or more sensors by generating a representative sensor value for each of a set of successive time intervals, wherein generating a representative sensor value comprises determining one: of an average, median and last data value for the time interval.

28. (canceled)

29. The method according to claim 1, further comprising training a plurality of neural networks having different input sensor sets and/or different output sensor sets.

30. A method according to claim 1, wherein the neural network comprises one or both of:
a sequence-to-sequence model, in the form of a sequence-to-sequence autoencoder; and
recurrent neurons or long short term memory (LSTM) neurons.

31. (canceled)

32. The method according to claim 1,
wherein the process, system or machine comprises one of: a pressure control system for modifying the pressure of a fluid;
wherein the sensor signals provided as input to the neural network are optionally based on sensors for measuring one or more of: pressure, temperature, and vibration; and/or
wherein the regenerated output sensor signals are for one or more pressure sensors; and
a heating, ventilation and/or air-conditioning (HVAC) system.

33-34. (canceled)

35. A non-transitory computer readable medium comprising software code adapted, when executed on a data processing apparatus, to perform a operations that detect an operating state of a process, system or machine based on sensor signals from a plurality of sensors, the operations comprising:
receiving sensor data, the sensor data based on sensor signals from the plurality of sensors;
providing the sensor data as input to a neural network, the neural network comprising:
an encoder sub-network arranged to receive the sensor data as input and to generate a context vector based on the sensor data, wherein the encoder sub-network is adapted to encode sensor data patterns from the plurality of sensors over a predetermined time window; and
a decoder sub-network arranged to receive the context vector as input and to regenerate sensor data corresponding to at least a subset of the sensors based on the context vector;
comparing the context vector to at least one context vector classification;
detecting an operating state in dependence on the comparison; and
outputting a notification indicating the detected operating state.

36. A system comprising:
a plurality of sensors; and
a processor and associated memory configured for detecting an operating state of a process, system or machine based on sensor signals from the plurality of sensors, the processor configured to:
receive sensor data, the sensor data based on sensor signals from the plurality of sensors;
provide the sensor data as input to a neural network, the neural network comprising:
an encoder sub-network arranged to receive the sensor data as input and to generate a context vector based on the sensor data, wherein the encoder sub-network is adapted to encode sensor data patterns from the plurality of sensors over a predetermined time window;
a decoder sub-network arranged to receive the context vector as input and to regenerate sensor data corresponding to at least a subset of the sensors based on the context vector;
compare the context vector to at least one context vector classification;
detect an operating state in dependence on the comparison; and
output a notification indicating the detected operating state.

37. (canceled)
